(19) United States
(12) Patent Application Publication
(10) Pub. No.: US 2026/0239327 A1
(43) Pub. Date: Aug. 13, 2026

(54) TRANSMISSION CONFIGURATION INDICATOR STATES FOR SPATIAL BEAM PREDICTION

(71) Applicant: QUALCOMM Incorporated, San Diego, CA (US)

(72) Inventors: Qiaoyu LI, Beijing (CN); Mahmoud TAHERZADEH BOROUJENI, San Diego, CA (US); Hamed PEZESHKI, San Diego, CA (US)

(21) Appl. No.: 19/156,803

(22) PCT Filed: Mar. 31, 2023
(86) PCT No.: PCT/CN2023/085371

§ 371 Date: Aug. 14, 2025

(51) Int. Cl. H04W 72/044; H04L 5/00; H04W 72/542

(52) U.S. Cl. CPC H04W 72/046; H04L 5/0096; H04W 72/542

(57) ABSTRACT

Methods, systems, and devices for wireless communications are described. A user equipment (UE) may receive control signaling configuring one or more transmission configuration indicator (TCI) states with reference resources associated with channel characteristics prediction configurations. The UE may receive a control message indicating a transmission configuration indicator state of the one or more transmission configuration indicator states, the transmission configuration indicator state having a reference resource associated with a channel characteristics prediction configuration. The UE may select a receive beam or a transmit beam, or both, based on the reference resource associated with the channel characteristics prediction configuration.

### CROSS REFERENCE

The present Application is a 371 national phase filing of International PCT Application No. PCT/CN2023/085371 by LI et al., entitled “TRANSMISSION CONFIGURATION INDICATOR STATES FOR SPATIAL BEAM PREDICTION,” filed Mar. 31, 2023, which is assigned to the assignee hereof, and which is expressly incorporated by reference in its entirety herein.

### FIELD OF TECHNOLOGY

The following relates to wireless communications, including transmission configuration indicator states for spatial beam prediction.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support transmission configuration indicator (TCI) states for spatial beam prediction. For example, the described techniques provide for configuring a user equipment (UE) with one or more TCI states that have a reference resource that is associated with channel characteristics prediction configurations. For example, the TCI states may have a reference resource that is associated with a channel measurement resource (CMR) that is used by the UE to obtain measurements and generate predictions. In some examples, the TCI states may have a reference resource that is associated with a channel state information (CSI) report setting that is used to transmit a CSI report and indicate predicted channel characteristics. The UE may receive a control message indicating a TCI state of the one or more TCI states. The TCI state may have a reference resource associated with a channel characteristics prediction configuration, such as a CMR set or a CSI report setting associated with channel characteristics prediction. The UE may select a receive beam or a transmit beam, or both, based on the reference resource associated with the channel characteristics prediction configuration.

A method for wireless communications at a UE is described. The method may include receiving control signaling configuring one or more TCI states with reference resources associated with channel characteristics prediction configurations, receiving a control message indicating a TCI state of the one or more TCI states, the TCI state having a reference resource associated with a channel characteristics prediction configuration, and selecting a receive beam or a transmit beam, or both, based on the reference resource associated with the channel characteristics prediction configuration.

An apparatus for wireless communications at a UE is described. The apparatus may include a processor, memory coupled with the processor, and instructions stored in the memory. The instructions may be executable by the processor to cause the apparatus to receive control signaling configuring one or more TCI states with reference resources associated with channel characteristics prediction configurations, receive a control message indicating a TCI state of the one or more TCI states, the TCI state having a reference resource associated with a channel characteristics prediction configuration, and select a receive beam or a transmit beam, or both, based on the reference resource associated with the channel characteristics prediction configuration.

Another apparatus for wireless communications at a UE is described. The apparatus may include means for receiving control signaling configuring one or more TCI states with reference resources associated with channel characteristics prediction configurations, means for receiving a control message indicating a TCI state of the one or more TCI states, the TCI state having a reference resource associated with a channel characteristics prediction configuration, and means for selecting a receive beam or a transmit beam, or both, based on the reference resource associated with the channel characteristics prediction configuration.

A non-transitory computer-readable medium storing code for wireless communications at a UE is described. The code may include instructions executable by a processor to receive control signaling configuring one or more TCI states with reference resources associated with channel characteristics prediction configurations, receive a control message indicating a TCI state of the one or more TCI states, the TCI state having a reference resource associated with a channel characteristics prediction configuration, and select a receive beam or a transmit beam, or both, based on the reference resource associated with the channel characteristics prediction configuration.

In some examples of the method, apparatuses, and non-transitory computer-readable medium described herein, receiving the control message may include operations, features, means, or instructions for receiving, via the control message, an indication of the TCI state that identifies a set of CMRs as the reference resource, where selecting the receive beam or the transmit beam may be based at least part on channel characteristics predicted via the set of CMRs.

In some examples of the method, apparatuses, and non-transitory computer-readable medium described herein, receiving the control message may include operations, features, means, or instructions for receiving, via the control message, an indication of the TCI state that identifies a channel state information report setting as the reference resource, where selecting the receive beam or the transmit beam may be based at least part on a channel state information report for channel characteristics predictions associated with the channel state information report setting.

In some examples of the method, apparatuses, and non-transitory computer-readable medium described herein, receiving the control message may include operations, features, means, or instructions for receiving, via the control message, an indication to activate the TCI state of the one or more TCI states.

In some examples of the method, apparatuses, and non-transitory computer-readable medium described herein, the control signaling configures one or more quasi co-location (QCL) associations associated with the channel characteristics prediction configurations and the TCI state indicates a QCL association to the reference resource associated with the channel characteristics prediction configuration.

Some examples of the method, apparatuses, and non-transitory computer-readable medium described herein may further include operations, features, means, or instructions for receiving, based on the control message, downlink signaling using the receive beam with a spatial filter that may be associated with the reference resource.

Some examples of the method, apparatuses, and non-transitory computer-readable medium described herein may further include operations, features, means, or instructions for selecting the receive beam or the transmit beam during a time domain window based on channel characteristic predictions associated with the reference resource.

Some examples of the method, apparatuses, and non-transitory computer-readable medium described herein may further include operations, features, means, or instructions for selecting the receive beam or the transmit beam in a radio frequency spectrum band that may be based on channel characteristic predictions associated with the reference resource.

In some examples of the method, apparatuses, and non-transitory computer-readable medium described herein, the TCI state identifies a channel state information report setting and selecting the receive beam or the transmit beam may be based on the channel state information report setting.

In some examples of the method, apparatuses, and non-transitory computer-readable medium described herein, the control message includes an identifier of one or more predicted channel characteristics associated with the reference resource and selecting the receive beam or the transmit beam may be based on the identifier of the one or more predicted channel characteristics.

In some examples of the method, apparatuses, and non-transitory computer-readable medium described herein, the TCI state includes an identifier of one or more predicted channel characteristics associated with the reference resource and selecting the receive beam or the transmit beam may be based on the identifier of the one or more predicted channel characteristics.

In some examples of the method, apparatuses, and non-transitory computer-readable medium described herein, the receive beam or the transmit beam may be selected based on channel characteristics predictions associated with the reference resource in a most recent channel state information report transmitted by the UE.

In some examples of the method, apparatuses, and non-transitory computer-readable medium described herein, the TCI state includes a serving cell identifier or a frequency range identifier, or both.

In some examples of the method, apparatuses, and non-transitory computer-readable medium described herein, the reference resource may be associated with a spatial domain channel characteristics prediction, a time domain channel characteristics prediction, or a frequency domain channel characteristics prediction, or any combination thereof.

A method for wireless communications at a network entity is described. The method may include transmitting, to a UE, control signaling configuring one or more TCI states with reference resources associated with channel characteristics prediction configurations, transmitting a control message indicating a TCI state of the one or more TCI states, the TCI state having a reference resource associated with a channel characteristics prediction configuration, and communicating with the UE using a receive beam or a transmit beam, or both, based on the reference resource associated with the channel characteristics prediction configuration.

An apparatus for wireless communications at a network entity is described. The apparatus may include a processor, memory coupled with the processor, and instructions stored in the memory. The instructions may be executable by the processor to cause the apparatus to transmit, to a UE, control signaling configuring one or more TCI states with reference resources associated with channel characteristics prediction configurations, transmit a control message indicating a TCI state of the one or more TCI states, the TCI state having a reference resource associated with a channel characteristics prediction configuration, and communicate with the UE using a receive beam or a transmit beam, or both, based on the reference resource associated with the channel characteristics prediction configuration.

Another apparatus for wireless communications at a network entity is described. The apparatus may include means for transmitting, to a UE, control signaling configuring one or more TCI states with reference resources associated with channel characteristics prediction configurations, means for transmitting a control message indicating a TCI state of the one or more TCI states, the TCI state having a reference resource associated with a channel characteristics prediction configuration, and means for communicating with the UE using a receive beam or a transmit beam, or both, based on the reference resource associated with the channel characteristics prediction configuration.

A non-transitory computer-readable medium storing code for wireless communications at a network entity is described. The code may include instructions executable by a processor to transmit, to a UE, control signaling configuring one or more TCI states with reference resources associated with channel characteristics prediction configurations, transmit a control message indicating a TCI state of the one or more TCI states, the TCI state having a reference resource associated with a channel characteristics prediction configuration, and communicate with the UE using a receive beam or a transmit beam, or both, based on the reference resource associated with the channel characteristics prediction configuration.

In some examples of the method, apparatuses, and non-transitory computer-readable medium described herein, transmitting the control message may include operations, features, means, or instructions for transmitting, via the control message, an indication of the TCI state that identifies a set of CMRs as the reference resource, where the receive beam or the transmit beam may be based at least part on channel characteristics predicted via the set of CMRs.

In some examples of the method, apparatuses, and non-transitory computer-readable medium described herein, transmitting the control message may include operations, features, means, or instructions for transmitting, via the control message, an indication of the TCI state that identifies a channel state information report setting as the reference resource, where the receive beam or the transmit beam may be based at least part on a received channel state information report for channel characteristics predictions associated with the channel state information report setting.

In some examples of the method, apparatuses, and non-transitory computer-readable medium described herein, transmitting the control message may include operations, features, means, or instructions for transmitting, via the control message, an indication to activate the TCI state of the one or more TCI states.

In some examples of the method, apparatuses, and non-transitory computer-readable medium described herein, the control signaling configures one or more QCL associations associated with the channel characteristics prediction configurations and the TCI state indicates a QCL association to the reference resource associated with the channel characteristics prediction configuration.

Some examples of the method, apparatuses, and non-transitory computer-readable medium described herein may further include operations, features, means, or instructions for transmitting, based on the control message, downlink signaling using the transmit beam with a spatial filter that may be associated with the reference resource.

Some examples of the method, apparatuses, and non-transitory computer-readable medium described herein may further include operations, features, means, or instructions for selecting the receive beam or the transmit beam during a time domain window based on channel characteristic predictions associated with the reference resource.

Some examples of the method, apparatuses, and non-transitory computer-readable medium described herein may further include operations, features, means, or instructions for selecting the receive beam or the transmit beam in a radio frequency spectrum band that may be based on channel characteristic predictions associated with the reference resource.

In some examples of the method, apparatuses, and non-transitory computer-readable medium described herein, the TCI state identifies a channel state information report setting and the receive beam or the transmit beam may be based on the channel state information report setting.

In some examples of the method, apparatuses, and non-transitory computer-readable medium described herein, the control message includes an identifier of one or more predicted channel characteristics associated with the reference resource and the receive beam or the transmit beam may be based on the identifier of the one or more predicted channel characteristics.

In some examples of the method, apparatuses, and non-transitory computer-readable medium described herein, the TCI state includes an identifier of one or more predicted channel characteristics associated with the reference resource and the receive beam or the transmit beam may be based on the identifier of the one or more predicted channel characteristics.

In some examples of the method, apparatuses, and non-transitory computer-readable medium described herein, the TCI state may be based on channel characteristics predictions associated with the reference resource in a most recent channel state information report received from the UE.

In some examples of the method, apparatuses, and non-transitory computer-readable medium described herein, the TCI state includes a serving cell identifier or a frequency range identifier, or both.

In some examples of the method, apparatuses, and non-transitory computer-readable medium described herein, the reference resource may be associated with a spatial domain channel characteristics prediction, a time domain channel characteristics prediction, or a frequency domain channel characteristics prediction, or any combination thereof.

### BRIEF DESCRIPTION OF THE DRAWINGS

FIG. 1 shows an example of a wireless communications system that supports transmission configuration indicator (TCI) states for spatial beam prediction in accordance with one or more aspects of the present disclosure.

FIG. 2 shows an example of a wireless communications system that supports TCI states for spatial beam prediction in accordance with one or more aspects of the present disclosure.

FIG. 3 shows an example of a process flow that supports TCI states for spatial beam prediction in accordance with one or more aspects of the present disclosure.

FIGS. 4 and 5 show block diagrams of devices that support TCI states for spatial beam prediction in accordance with one or more aspects of the present disclosure.

FIG. 6 shows a block diagram of a communications manager that supports TCI states for spatial beam prediction in accordance with one or more aspects of the present disclosure.

FIG. 7 shows a diagram of a system including a device that supports TCI states for spatial beam prediction in accordance with one or more aspects of the present disclosure.

FIGS. 8 and 9 show block diagrams of devices that support TCI states for spatial beam prediction in accordance with one or more aspects of the present disclosure.

FIG. 10 shows a block diagram of a communications manager that supports TCI states for spatial beam prediction in accordance with one or more aspects of the present disclosure.

FIG. 11 shows a diagram of a system including a device that supports TCI states for spatial beam prediction in accordance with one or more aspects of the present disclosure.

FIGS. 12 through 15 show flowcharts illustrating methods that support TCI states for spatial beam prediction in accordance with one or more aspects of the present disclosure.

### DETAILED DESCRIPTION

Some wireless communications systems may support beam prediction or channel characteristic prediction using artificial intelligence or a machine learning model. A user equipment (UE) may measure reference signals using a first set of receive beams and use the measurements to predict channel characteristics for a different, second set of receive beams. For example, the UE may perform spatial domain beam prediction to predict preferred downlink receive beams based on the measurements of the first set of receive beams that are associated with a channel measurement resource. In some examples, the UE may report the predictions for the second set of receive beams to a network entity. The UE may perform codebook based spatial domain beam prediction or non-codebook based spatial domain beam prediction. For codebook based spatial domain beam prediction, the UE may indicate predicted channel characteristics such as a preferred candidate resources out of a set of candidate resources configured by the network entity. For non-codebook based spatial domain beam prediction, the UE may indicate predicted channel characteristics such as a preferred downlink angle-of-arrival (AoA), or a preferred direction corresponding to the strongest or highest predicted channel characteristics. In some examples, the UE may indicate predicted measurements for the preferred downlink AoA, preferred beam direction, or preferred predicted beam. The network entity may select a downlink transmit beam based on the prediction information from the UE and schedule a downlink transmission using the downlink transmit beam.

For non-prediction based signaling, a network entity may configure a UE with transmission configuration indicator (TCI) states, which may indicate that scheduled signaling shares some characteristics, such as a spatial direction, with a previously received signaling. For example, a TCI state indication may quasico-locate the scheduled signaling with another, previously received signal, such as a channel state information reference signal (CSI-RS) or a synchronization signal block (SSB). However, as current techniques for a TCI state indicate a quasico-location to actually received signals, a TCI state in current systems may not be able to indicate beam directions based on predictions

The present disclosure provides techniques to support a TCI state associated with spatial beam prediction. For example, a UE may be configured with a TCI state that has a reference resource associated with a CMR or measurement beams that are used for beam predictions. For example, the UE may measure signals via a set of measurement beams that are based on a CMR, predict channel characteristics based on the measurements, and report the predicted channel characteristics via a CSI report. The network entity may receive the predicted channel characteristics and select a downlink transmit beam based on the predicted beam information. The network entity may transmit a TCI state indication that refers to the CMR set (e.g., used to generate the predicted beam information) as a reference resource to indicate spatial domain information for the selected downlink transmit beam. The UE may identify spatial filters for a transmit beam or receive beam, or both, based on the predicted channel characteristics associated with the indicated CMR set in the corresponding TCI state. In some aspects, the reference resource for a TCI state associated with beam prediction may be based on a CSI report setting. For example, the TCI state may refer to or indicate a CSI report setting identifier for a CSI report setting used to report predicted channel characteristics.

Aspects of the disclosure are initially described in the context of wireless communications systems. Aspects of the disclosure are further illustrated by and described with reference to a process flow, apparatus diagrams, system diagrams, and flowcharts that relate to TCI states for spatial beam prediction.

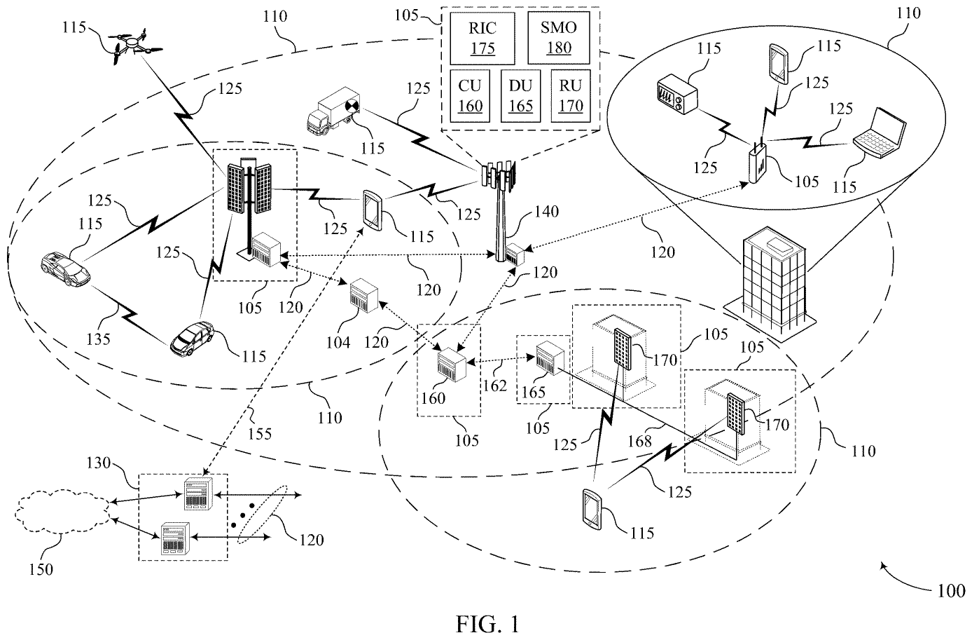

FIG. 1 shows an example of a wireless communications system 100 that supports TCI states for spatial beam prediction in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUS 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (VIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support TCI states for spatial beam prediction as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

The wireless communications system 100 may support beam prediction or channel characteristic prediction using artificial intelligence or a machine learning model. A UE 115 may measure reference signals using a first set of receive beams and use the measurements to predict channel characteristics for a different, second set of receive beams. For example, the UE 115 may perform spatial domain beam prediction to predict preferred downlink receive beams based on the measurements of the first set of receive beams that are associated with a channel measurement resource. In some examples, the UE 115 may report the predictions for the second set of receive beams to a network entity. The UE 115 may perform codebook based spatial domain beam prediction or non-codebook based spatial domain beam prediction. For codebook based spatial domain beam prediction, the UE 115 may indicate predicted channel characteristics such as a preferred candidate resources out of a set of candidate resources configured by the network entity. For non-codebook based spatial domain beam prediction, the UE 115 may indicate predicted channel characteristics such as a preferred downlink AoA, or a preferred direction corresponding to the strongest or highest predicted channel characteristics. In some examples, the UE 115 may indicate predicted measurements for the preferred downlink AoA, preferred beam direction, or preferred predicted beam. The network entity may select a downlink transmit beam based on the prediction information from the UE and schedule a downlink transmission using the downlink transmit beam.

The wireless communications system 100 may support a TCI state associated with spatial beam prediction. For example, a UE 115 may be configured with a TCI state that has a reference resource associated with a CMR or measurement beams that are used for beam predictions. For example, the UE 115 may measure signals via a set of measurement beams that are based on a CMR, predict channel characteristics based on the measurements, and report the predicted channel characteristics via a CSI report. The network entity may receive the predicted channel characteristics and select a downlink transmit beam based on the predicted beam information. The network entity 105 may transmit a TCI state indication that refers to the CMR set (e.g., used to generate the predicted beam information) as a reference resource to indicate spatial domain information for the selected downlink transmit beam. The UE 115 may identify spatial filters for a transmit beam or receive beam, or both, based on the predicted channel characteristics associated with the indicated CMR set in the corresponding TCI state. In some aspects, the reference resource for a TCI state associated with beam prediction may be based on a CSI report setting. For example, the TCI state may refer to or indicate a CSI report setting identifier for a CSI report setting used to report predicted channel characteristics.

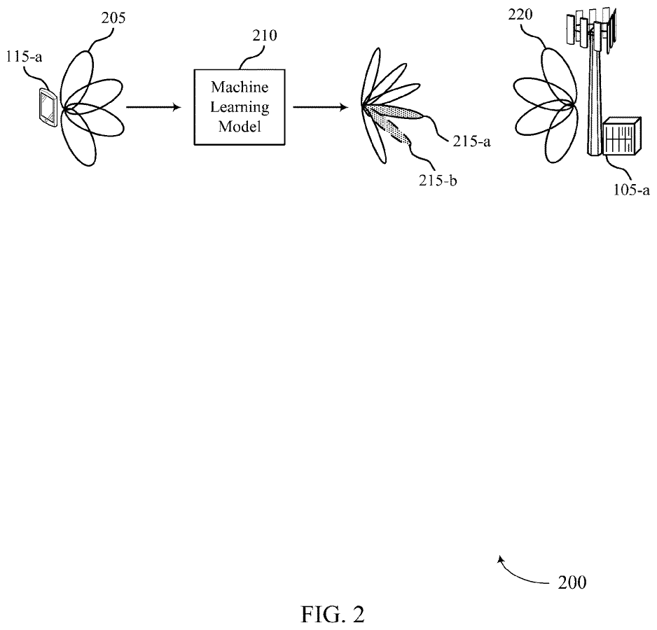

FIG. 2 shows an example of a wireless communications system 200 that supports TCI states for spatial beam prediction in accordance with one or more aspects of the present disclosure. The wireless communications system 200 may implement aspects of the wireless communications system 100 or may be implemented by aspects of the wireless communications system 100 as described with reference to FIG. 1. For example, the wireless communications system 200 may include a network entity 105-a and a UE 115-a, which may be examples of corresponding devices as described with reference to FIG. 1.

Some wireless communications systems, such as the wireless communications system 200, may support codebook based beam prediction techniques or non-codebook based beam prediction techniques, or both. In some examples, non-codebook based beam prediction may be based on virtual resources or AoAs from a network entity 105, which may not correspond to actual beams or actual beam directions supported by the network entity 105. In non-codebook based beam prediction, a UE 115 may predict preferred downlink AoAs or channel characteristics for the downlink AoAs, or both. For example, the UE 115 may predict an associated reference signal received power (RSRP) for a predicted downlink AoA, an associated SINR for the predicted downlink AoA, or both.

In codebook based beam prediction, a UE 115 may indicate preferred candidate resources or predicted channel characteristics for candidate resources that are indicated by, or actually supported or available at, a network entity 105. For example, in codebook based beam prediction, predicted channel characteristics may include one or more preferred candidate resources, which may include virtual candidate resources, of a candidate resource set indicated by the network entity 105. In some examples, the UE 115 may indicate an associated RSRP or an associated SINR for the preferred candidate resources.

In some examples, the UE 115-a may perform non-codebook based spatial domain beam prediction. For example, the UE 115-a may measure channel characteristics for a set of measurement beams 205 and predict a preferred downlink AoA. The network entity 105-a may transmit the reference signals via a set of one or more network entity beams 220. In some examples, the UE 115-a may additionally, or alternatively, predict a preferred downlink receive beam associated with the predicted downlink AoA. In some examples, the measurement beams 205 may be referred to as Set-B beams and may, for example, be wide beams formed from synchronization signal blocks (SSBs) transmitted by a network entity 105 (e.g., the network entity 105-a).

Based on the measurements of the set of measurement beams 205, the UE 115-a may use a machine learning model 210 to obtain or identify predicted beams 215 or channel characteristics associated with the predicted beams 215. For example, the UE 115-a may input the measurements into the machine learning model 210, and the machine learning model 210 may output predicted channel characteristics for downlink beams. In some examples, the UE 115-a may identify, or the machine learning model 210 may output, information associated with receive beams that correspond to the predicted channel characteristics for the downlink beams. For example, the UE 115-a may predict which downlink transmit beams will be strongest in a future time slot, in a different frequency domain, or in different directions, and the UE 115-a may also identify corresponding receive beams for the downlink transmit beams. In some examples, the predicted beams 215 may correspond to a beam supported by the UE 115-a, a predicted downlink AoA, or both. For example, the predicted beams 215 may be examples of downlink AoAs, which may not correspond to actual receive beams supported by the UE 115-a or actual transmit beams supported by the network entity 105-a, or both.

The UE 115-a may perform predictions for beams in one or more domains. In some examples, the UE 115-a may perform spatial domain prediction. In non-codebook based spatial domain prediction, predicted channel characteristics may include downlink AoAs and an associated RSRP or an associated SINR for the preferred candidate resources. In codebook based spatial domain prediction, predicted channel characteristics may include one or more preferred candidate resources from a set of candidate resources indicated by the network entity 105-a. The UE 115-a may additionally or alternatively predict an associated RSRP or an associated SINR. In some examples, the UE 115-a may perform channel characteristics predictions in the spatial domain and the time domain. For example, the UE 115-a may make spatial domain predictions regarding one or more future occasions. In some examples, the UE 115-a may perform predictions in the spatial domain and the frequency domain. For example, the UE 115-a may make spatial domain predictions regarding a different FR than the FR used to perform the measurements or a different serving cell than the serving cell used to perform the measurements. In some examples, the UE 115-a may perform channel characteristics predictions in the spatial domain, the frequency domain, and the time domain. For example, the UE 115-a may make spatial domain predictions regarding another FR or another serving cell and regarding one or more future occasions.

In some examples, the UE 115-a may transmit an indication of predicted channel characteristics to the network entity 105-a. For example, the UE 115-a may indicate the predicted beams 215 or channel characteristics for the predicted beams 215. In some cases, the predicted beams 215 may correspond to preferred predicted beams based on the predicted channel characteristics. In some examples, the UE 115-a may indicate predicted RSRPs with respect to the predicted beams 215. In some examples, the network entity 105-a may be aware that the predicted beams 215, or information associated with the predicted beams 215, are based on measurements taken by the UE 115-a using the measurement beams 205. For example, the network entity 105-a may be aware that the predicted beams 215 are associated with the measurement beams 205 or a set of CMRs that are associated with the measurement beams 205. In some examples, the network entity 105-a may select an appropriate transmit or receive beam for communications with the UE 115-a based on the indication predicted channel characteristics (e.g., the indication of the predicted beams 215) received from the UE 115-a. In some examples, the network entity 105-a may schedule downlink data transmissions, such as physical downlink shared channel (PDSCH) transmissions, using a downlink transmit beam that is based on the predicted beams 215.

Some systems may use a TCI state with a reference resource corresponding to an actually transmitted reference signal to indicate spatial filters for receive or transmit beams to a UE 115. When the UE 115 reports beam predictions to a network entity 105, and the network entity 105 schedules signaling based on the beam predictions, the predicted beams may not correspond to beams which have actually been used for reference signal transmission. However, techniques in these systems for a TCI state to indicate a reference signal, such as a CSI-RS or an SSB, may not support indicating a spatial relation for a predicted beam. For example, the network entity 105-a may not have actually transmitted signaling using the predicted beam, or the predicted beam may correspond to a downlink AoA which does not correspond to an actual downlink transmit beam of the network entity 105.

The wireless communications system 200 may support a TCI state associated with spatial domain beam prediction. For example, the TCI state may be based on measurement beams (e.g., the measurement beams 205) or based on a CSI report setting associated with prediction reporting. For example, the network entity 105-a may configure the UE 115-a with one or more TCI states that refer to the measurement beams 205 which are used to predict the predicted beams 215, or refer to a CMR set associated with the measurement beams 205. The measurement beams 205 may be based on a CMR set, the UE 115-a may report the predicted beams 215, or information associated with the predicted beams 215, via a CSI report.

For example, the UE 115-a may be configured with or indicated a TCI state, where the reference resource associated with the TCI state may be defined based on one or more CMR sets. In some examples, the network entity 105-a may configure the UE 115-a with one or more TCI states where a reference resource for the one or more TCI states is a CMR set that is associated with one or more sets of Set-B beams, such as the measurement beams 205. The CMR sets may include, or be associated with, SSBs, non-zero-power CSI-RS, or any combination thereof. In some examples, the TCI state may be indicated via a TCI state activation MAC-CE or via a downlink control information (DCI) switching TCI states. For example, the network entity 105-a may transmit an activation MAC-CE or a DCI to the UE 115-a to activate the indicated TCI state or switch the UE 115-a to the indicated TCI state. For such TCI states, the CMR set or CMR sets used as the reference resource may have been used previously by the UE 115-a as measurement resources to predict and/or report channel characteristics. When such a TCI state is activated, the UE 115-a may identify appropriate transmission and/or reception spatial filters based on the predicted channel characteristics associated with the indicated CMR set in the corresponding TCI state.

In some examples, the UE 115-a may support a first type of TCI state associated with channel measurement predictions that is based on a downlink or unified TCI state or TCI uplink state configuration. In some examples, a quasi co-located (QCL) source reference signal the first type of TCI state may be associated with measurement predictions. For example, the Type-D QCL source reference signal may refer to a CMR set associated with the measurement beams 205. In some examples, a CMR set may be used as a source reference signal for a downlink TCI state, a unified TCI state, or an uplink TCI state. For example, instead of referring to an actually transmitted reference signal, the TCI state may refer to the CMR set which was used to generate beam predictions or channel characteristic predictions.

Additionally, or alternatively, the UE 115-a may support a second type of TCI state. For example, an associated reference source of the second type of TCI state may be based on one or more CMR sets. In some examples, the second type of TCI state may be associated with beam prediction. The second type of TCI state may be defined for unified or downlink TCI states and uplink TCI states. In some examples, the network entity 105-a may transmit a MAC-CE to activate the TCI states. In some examples, the MAC-CE may jointly activate the first type of TCI state and the second type of TCI state. In other examples, the MAC-CE may be used to dedicatedly activate the second type of TCI state.

In some examples, a TCI state may indicate a CSI report setting identifier associated with the CMR set or CMR sets. For example, the TCI state may indicate a CSI report setting identifier used to predict the predicted beam 215 that was selected by the network entity 105-a. In some examples, the UE 115-a may have used a same CMR set for beam predictions for different serving cells. For example, in cross-FR beam prediction, a first CMR set at a first serving cell may be used with a first CSI report setting to predict and/or report the predicted beams 215 for the first serving cell. The first CMR set may also be used with a second CSI report setting to predict and/or report the predicted beams 215 for a second serving cell. Thus, indicating only the first CMR set in a TCI state may cause ambiguity issues for the UE 115-a. By indicating a CSI report setting ID associated with the CMR set, the UE 115-a may identify which prediction or predicted beam 215 the TCI state refers to. In some examples, the network entity 105-a may include an indication of the CSI report setting identifier in the TCI state. Additionally, or alternatively, the network entity 105-a may include an indication of the CSI report setting identifier in control signaling indicating or activating the TCI state. For example, the network entity 105-a may include the indication of the CSI report setting identifier in a MAC CE activating or indicating the TCI state.

In some examples, the TCI state or signaling indicating the TCI state may include indications of the predicted beams 215 selected by the network entity 105-a. For example, the UE 115-a may have reported multiple sets of channel characteristics (e.g., preferred downlink AoAs, preferred virtual resource identifiers, predicted RSRPs or SINRs) based on a one or more CMR sets or CSI report settings indicated in the TCI state. A control signaling activating the TCI state (e.g., a MAC-CE activating the TCI state) may indicate an index of channel characteristics identifiers from the channel characteristics reported by the UE 115-a, which may identify the associated reference resource to use for determining transmission and reception spatial filters with respect to the TCI state. For example, the UE 115-a may report five sets of predicted channel characteristics to the network entity 105-a, and the network entity 105-a may select and transmit an indication that the third set of predicted channel characteristics is associated with the selected predicted beam. The UE 115-a or the network entity 105-a, or both, may then select spatial filters for transmit and receive beams based on beam predictions or channel characteristics predictions of the third set of predicted channel characteristics. Additionally, or alternatively, the index of the selected channel characteristics may be directly configured in the TCI state configuration (e.g., instead of indicated via control signaling which activates or indicates the TCI state).

In some examples, a TCI state associated with beam prediction may be configured to be associated with multiple CSI report setting identifiers. For example, the TCI state may have a reference resource associated with a CMR set, and the TCI state may also be associated with two CSI report setting identifiers. Control signaling which activates the TCI state may indicate one of the two CSI report setting identifiers, and the UE 115-a may identify a reference resource based on the CMR set associated with the TCI state and the indicated CSI report setting identifier.

For example, the measurement beams 205 may be used to obtain measurements and predict a predicted beam 215-a and a predicted beam 215-b. The UE 115-a may transmit beam prediction information for the predicted beam 215-a using a first CSI report setting, and the UE 115-a may transmit beam prediction information for the predicted beam 215-b using a second CSI report setting. The network entity 105-a may configure the UE 115-a with a TCI state that uses a CMR set corresponding to the measurement beams 205 as a reference resource. Additionally, a first CSI report setting identifier associated with the first CSI report setting and the second CSI report setting identifier associated with the second CSI report setting may be configured as candidates within the TCI state. A MAC-CE activating the TCI state may down-select one of the CSI report setting identifiers from the CSI report setting candidates. For example, the MAC-CE may indicate the first CSI report setting identifier associated with predicted beam 215-a from the preconfigured set.

In some examples, the TCI state may indicate spatial transmit or receive beam filters based on a timing of CSI reports indicating beam prediction information.

For example, the UE 115-a may determine transmission or reception spatial filters corresponding to an indicated TCI state based on the most recently predicted or reported channel characteristics associated with the CMR sets indicated in the TCI state. In some examples of time domain prediction of channel characteristics, the UE 115-a may predict and report channel characteristics regarding future time domain occasions or windows, and the network entity 105-a may indicate a TCI state associated with a CMR set used to obtain the time domain channel characteristics predictions. In some examples, the UE 115-a may determine transmission and reception spatial filters corresponding to the indicated TCI state based on the predicted and reported channel characteristics associated with respective time domain occasions or windows for signals transmitted or received during the respective time domain occasion or window. For example, if the time domain channel characteristics predictions are for a future slot, and the UE 115-a is indicated a TCI state based on the time domain channel characteristics predictions for the future slot, the UE 115-a may select spatial filters for a transmit beam or a receive beam during the future slot based on the channel characteristics predictions for the future slot.

In some examples, the TCI state may be defined based on a CSI report setting. For example, a reference resource for the TCI state may be based on or associated with a CSI report setting. The UE 115-a may report channel characteristics predictions via a CSI report according to a CSI report setting. A TCI state which indicates a CSI report setting as a reference resource may refer to a CSI report which indicated channel characteristics predictions. Therefore, the UE 115-a may be able to identify channel characteristics predictions and associated spatial filters for a transmit beam or a receive beam based on the identified channel characteristics predictions. For a TCI state indicated via a TCI activation message or a control message switching TCI states, the UE 115-a may have used a CMR set associated with the CSI report setting as measurement resources to predict or report channel characteristics. The UE 115-a may identify appropriate spatial filters for transmit and receive beams based on the predicted channel characteristics associated with the indicated CSI report setting in the corresponding TCI state when the TCI state is activated, or switched to, at the UE 115-a.

Some the additional parameters or configurations described with reference to TCI states defined based on a CMR set may be applied to TCI states defined based on a CSI report setting. For example, the channel characteristics associated with the indicated CSI report setting may be predictions in the spatial domain, the time domain, the frequency domain, or any combination thereof. In some examples, the UE 115-a may support a first type of TCI state defined based on a CSI report setting that is based on a downlink or unified TCI state or TCI uplink state configuration. Additionally, or alternatively, the UE 115-a may support a second type of TCI state defined based on a CSI report setting that may be defined for unified or downlink TCI states and uplink TCI states.

In some examples, a TCI state that is defined based on a CSI report setting, or a control message indicating or activating the TCI state that is defined based on a CSI report setting, may additionally include an identifier of a CMR set. In some examples, a control signaling activating the TCI state defined based on a CSI report setting (e.g., a MAC-CE activating the TCI state) may indicate an index of channel characteristics identifiers from the channel characteristics reported by the UE 115-a, which may identify the associated reference resource to use for determining transmission and reception spatial filters with respect to the TCI state. Additionally, or alternatively, the index of the selected channel characteristics may be directly configured in the TCI state configuration (e.g., instead of indicated via control signaling which activates or indicates the TCI state). In some examples, the TCI state may indicate spatial transmit or receive beam filters based on timelines of CSI reports indicating beam prediction information. In some examples of time domain prediction of channel characteristics, the UE 115-a may predict and report channel characteristics regarding future time domain occasions or windows, and the network entity 105-a may indicate a TCI state associated with a CSI report setting used to report the time domain channel characteristics predictions.

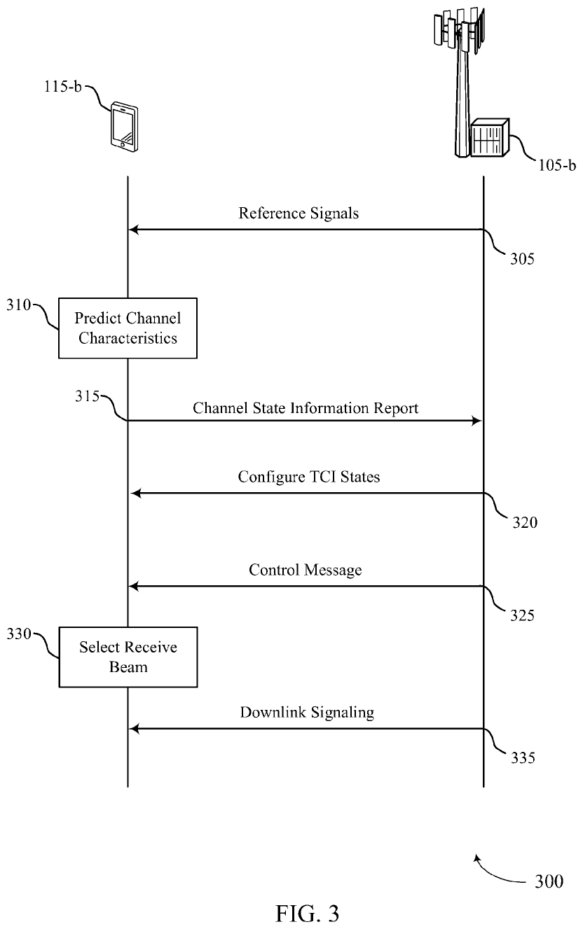

FIG. 3 shows an example of a process flow 300 that supports TCI states for spatial beam prediction in accordance with one or more aspects of the present disclosure. The process flow 300 include a UE 115-b and a network entity 105-b, which may be examples of a UE 115 and a network entity 105 as described with reference to FIGS. 1 and 2. Process flow 300 may illustrate TCI state indication for beam prediction to enable beam forming between the UE 115-b and the network entity 105-b.

In the following description of the process flow 300, the operations between the UE 115-b and the network entity 105-b may be transmitted in a different order than the exemplary order shown, or the operations performed by UE 115-b and the network entity 105-b may be performed in different orders or at different times. Certain operations may also be left out of the process flow 300, or other operations may be added to the process flow 300.

In some examples, at 305, the network entity 105-b may transmit, and the UE 115-b may receive, a set of reference signals. For example, the network entity 105-b may transmit one or more SSBs to the UE 115-b, or the network entity 105-b may transmit one or more CSI-RS to the UE 115-b. The UE 115-b may monitor for the set of reference signals and receive the set of reference signals via a set of measurement beams. In some examples, the set of measurement beams may be an example of Set B beams. The set of measurement beams may correspond to, or be associated with, a CMR set.

The UE 115-b may measure the channel characteristics of the one or more measurement beams (e.g., the measurement beams 205 described with reference to FIG. 2). The measured channel characteristics may include one or more RSRP measurements, or SINR measurements of the set of reference signals.

In some examples, at 310, the UE 115-b may predict channel characteristics of one or more predicted beams (e.g., a predicted beam 215 as described with reference to FIG. 2). The predictions may be spatial domain predictions, time domain predictions, frequency domain predictions, or any combination thereof. For example, the predictions may regard one or more future occasions, another FR, another serving cell, or any combination thereof. In some examples, the UE 115-b may predict a preferred downlink AoA based on the predicted channel characteristics. For example, based on the measurements of the one or more measurement beams, the machine learning model may identify beams, beam directions, or downlink AoAs that are predicted to have strong channel characteristics, such as high predicted RSRP values or high predicted SINR values. Additionally, or alternatively, the predicted channel characteristics may include a preferred downlink AoA.

In some examples, at 315, the UE 115-b may transmit, and the network entity 105-b may receive, a CSI report that may indicate the predicted channel characteristics predicted at 315. In some examples, the UE 115-b may transmit the CSI report in accordance with a CSI report setting. In some examples, the CSI report setting may be associated with a CMR set for the one or more measurement beams.

At 320, the network entity 105-b may transmit, and the UE 115-b may receive, control signaling configuring one or more TCI states with reference resources associated with channel characteristics prediction configurations. In some examples, the one or more TCI states may have a reference resource that is associated with a set of CMRs. For example, the set of CMRs may correspond to, or be associated with, the sets of measurement beams used by the UE 115-b to obtain measurements for performing predictions. In some examples, the one or more TCI states may have a reference resource that is associated with a CSI report setting. For example, the UE 115-b may have transmitted a CSI report in accordance with the CSI report setting to indicate predicted channel characteristics, such as a preferred predicted beam or a preferred downlink AoA.

In some examples, the control signaling may configure one or more QCL associations associated with the channel characteristics prediction configurations. The reference resources may be associated with a spatial domain channel characteristics prediction, a time domain channel characteristics prediction, a frequency domain channel characteristics prediction, or any combination thereof.

In some examples, the one or more TCI states may indicate one or more QCL associations to the reference resources associated with the channel characteristics prediction configuration. Additionally, or alternatively, the one or more TCI states may identify a CSI report setting (e.g., via a CSI report setting identifier). In some examples, the one or more TCI states may include an identifier of one or more predicted channel characteristics associated with the reference resource.

At 325, the network entity 105-b may transmit, and the UE 115-b may receive, a control message indicating a TCI state from a set of multiple TCI states. For example, the UE 115-b may receive a control message indicating a TCI state of the one or more TCI states. In some examples, the TCI state may have a reference resource associated with a channel characteristics prediction configuration. For example, the TCI state may have a reference resource associated with a CMR set or a CSI report setting. For example, the TCI state may identify a set of CMRs as the reference resource.

Additionally, or alternatively, the indicated TCI state may identify a CSI report setting as the reference resource. In some examples, the control message may activate the indicated TCI state. In some examples, the control message may include an identifier of one or more predicted channel characteristics associated with the reference resource. In some examples, the indicated TCI state may include a serving cell identifier, a frequency range identifier, or both.

At 330, the UE 115-b may select a receive beam, a transmit beam, or both based on the reference resource associated with the channel characteristics prediction configuration. The selection may be based on channel characteristics predicted via the set of channel measurement resources, the CSI report setting, a CSI report for channel characteristics predictions associated with the CSI report setting, the identifier of the one or more predicted channel characteristics included in either the control message or the TCI state, channel characteristics predictions associated with the reference resource in a most recent CSI report transmitted by the UE, or any combination thereof.

For example, the control message may indicate a TCI state associated with a CMR set. The UE 115-b may identify channel characteristic predictions associated with that CMR set. For example, the UE 115-b may have predicted that a downlink AoA will be a preferred downlink AoA or beam direction based on measurements made via that CMR set. The UE 115-b may select a receive beam that corresponds to the preferred downlink AoA that is associated with the CMR set indicated, or referred to, by the TCI state.

In some examples, the UE 115-b may select the receive beam or the transmit beam for a time domain window based on predicted channel characteristics associated with the reference resource. In additional or alternative examples, the receive beam or the transmit beam may be selected for a radiofrequency spectrum band that is based on channel characteristics predictions associated with the reference resource.

At 335, the network entity 105-b may transmit, and the UE 115-b may receive, downlink signaling based on the predicted channel characteristics. For example, the UE 115-b may receive the downlink signaling using the receive beam selected by the UE 115-b based on the reference resource associated with the channel characteristics prediction configuration. Additionally, or alternatively, the UE 115-b may transmit, to the network entity 105-b, uplink signaling using the transmit beam selected by the UE 115-b based on the reference resource associated with the channel characteristics prediction configuration. In some examples, the uplink signaling or downlink signaling may be transmitted using a spatial filter that is associated with the reference resource, based on the control message transmitted at 330.

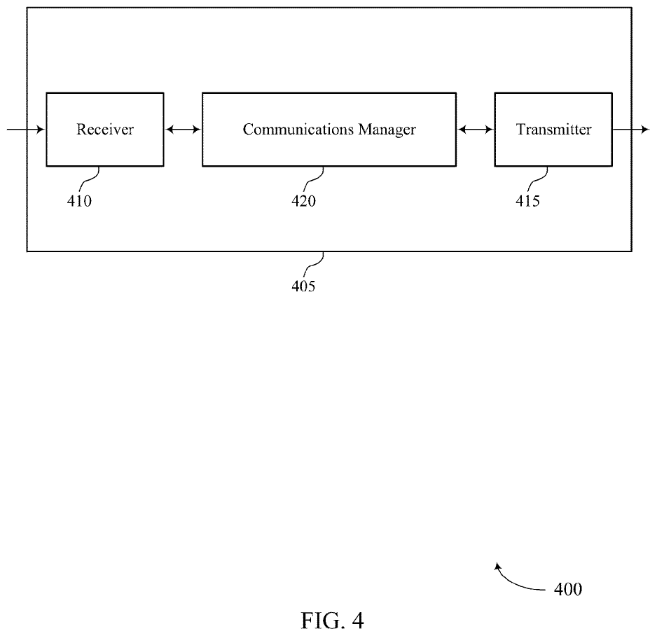

FIG. 4 shows a block diagram 400 of a device 405 that supports TCI states for spatial beam prediction in accordance with one or more aspects of the present disclosure. The device 405 may be an example of aspects of a UE 115 as described herein. The device 405 may include a receiver 410, a transmitter 415, and a communications manager 420. The device 405 may also include a processor. Each of these components may be in communication with one another (e.g., via one or more buses).

The receiver 410 may provide a means for receiving information such as packets, user data, control information, or any combination thereof associated with various information channels (e.g., control channels, data channels, information channels related to TCI states for spatial beam prediction). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to TCI states for spatial beam prediction). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations thereof or various components thereof may be examples of means for performing various aspects of TCI states for spatial beam prediction as described herein. For example, the communications manager 420, the receiver 410, the transmitter 415, or various combinations or components thereof may support a method for performing one or more of the functions described herein.

In some examples, the communications manager 420, the receiver 410, the transmitter 415, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 420, the receiver 410, the transmitter 415, or various combinations or components thereof may be implemented in code (e.g., as communications management software or firmware) executed by a processor. If implemented in code executed by a processor, the functions of the communications manager 420, the receiver 410, the transmitter 415, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 420 may be configured to perform various operations (e.g., receiving, obtaining, monitoring, outputting, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to obtain information, output information, or perform various other operations as described herein.

The communications manager 420 may support wireless communications at a UE in accordance with examples as disclosed herein. For example, the communications manager 420 is capable of, configured to, or operable to support a means for receiving control signaling configuring one or more transmission configuration indicator states with reference resources associated with channel characteristics prediction configurations. The communications manager 420 is capable of, configured to, or operable to support a means for receiving a control message indicating a transmission configuration indicator state of the one or more transmission configuration indicator states, the transmission configuration indicator state having a reference resource associated with a channel characteristics prediction configuration. The communications manager 420 is capable of, configured to, or operable to support a means for selecting a receive beam or a transmit beam, or both, based on the reference resource associated with the channel characteristics prediction configuration.

By including or configuring the communications manager 420 in accordance with examples as described herein, the device 405 (e.g., a processor controlling or otherwise coupled with the receiver 410, the transmitter 415, the communications manager 420, or a combination thereof) may support techniques for reduced processing and a more efficient utilization of communication resources by supporting a TCI state that is associated with beam predictions.

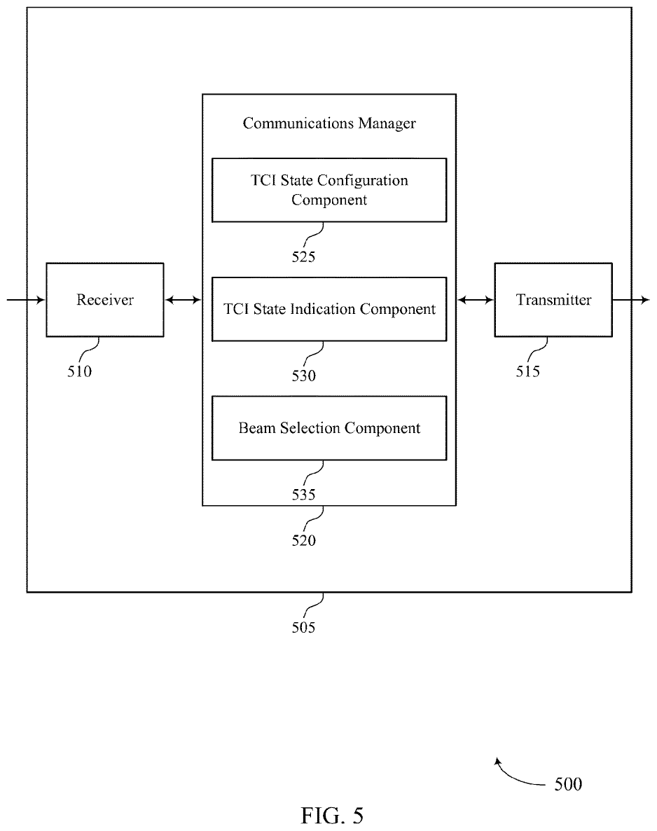

FIG. 5 shows a block diagram 500 of a device 505 that supports TCI states for spatial beam prediction in accordance with one or more aspects of the present disclosure. The device 505 may be an example of aspects of a device 405 or a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to TCI states for spatial beam prediction). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to TCI states for spatial beam prediction). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of TCI states for spatial beam prediction as described herein. For example, the communications manager 520 may include a TCI state configuration component 525, a TCI state indication component 530, a beam selection component 535, or any combination thereof. The communications manager 520 may be an example of aspects of a communications manager 420 as described herein. In some examples, the communications manager 520, or various components thereof, may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications at a UE in accordance with examples as disclosed herein. The TCI state configuration component 525 is capable of, configured to, or operable to support a means for receiving control signaling configuring one or more transmission configuration indicator states with reference resources associated with channel characteristics prediction configurations. The TCI state indication component 530 is capable of, configured to, or operable to support a means for receiving a control message indicating a transmission configuration indicator state of the one or more transmission configuration indicator states, the transmission configuration indicator state having a reference resource associated with a channel characteristics prediction configuration. The beam selection component 535 is capable of, configured to, or operable to support a means for selecting a receive beam or a transmit beam, or both, based on the reference resource associated with the channel characteristics prediction configuration.

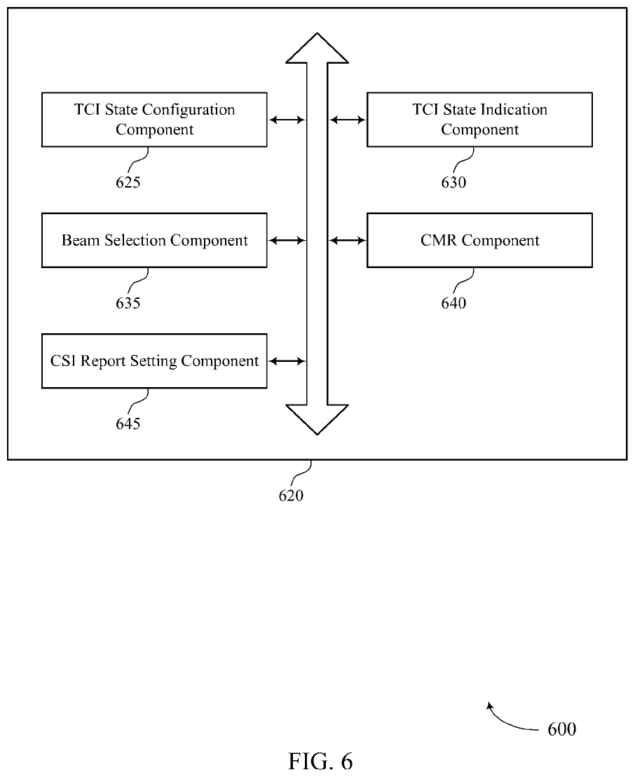

FIG. 6 shows a block diagram 600 of a communications manager 620 that supports TCI states for spatial beam prediction in accordance with one or more aspects of the present disclosure. The communications manager 620 may be an example of aspects of a communications manager 420, a communications manager 520, or both, as described herein. The communications manager 620, or various components thereof, may be an example of means for performing various aspects of TCI states for spatial beam prediction as described herein. For example, the communications manager 620 may include a TCI state configuration component 625, a TCI state indication component 630, a beam selection component 635, an CMR component 640, a CSI report setting component 645, or any combination thereof. Each of these components may communicate, directly or indirectly, with one another (e.g., via one or more buses).

The communications manager 620 may support wireless communications at a UE in accordance with examples as disclosed herein. The TCI state configuration component 625 is capable of, configured to, or operable to support a means for receiving control signaling configuring one or more transmission configuration indicator states with reference resources associated with channel characteristics prediction configurations. The TCI state indication component 630 is capable of, configured to, or operable to support a means for receiving a control message indicating a transmission configuration indicator state of the one or more transmission configuration indicator states, the transmission configuration indicator state having a reference resource associated with a channel characteristics prediction configuration.

The beam selection component 635 is capable of, configured to, or operable to support a means for selecting a receive beam or a transmit beam, or both, based on the reference resource associated with the channel characteristics prediction configuration.

In some examples, to support receiving the control message, the CMR component 640 is capable of, configured to, or operable to support a means for receiving, via the control message, an indication of the transmission configuration indicator state that identifies a set of channel measurement resources as the reference resource, where selecting the receive beam or the transmit beam is based at least part on channel characteristics predicted via the set of channel measurement resources.

In some examples, to support receiving the control message, the CSI report setting component 645 is capable of, configured to, or operable to support a means for receiving, via the control message, an indication of the transmission configuration indicator state that identifies a channel state information report setting as the reference resource, where selecting the receive beam or the transmit beam is based at least part on a channel state information report for channel characteristics predictions associated with the channel state information report setting.

In some examples, to support receiving the control message, the TCI state indication component 630 is capable of, configured to, or operable to support a means for receiving, via the control message, an indication to activate the transmission configuration indicator state of the one or more transmission configuration indicator states.

In some examples, the control signaling configures one or more QCL associations associated with the channel characteristics prediction configurations. In some examples, the transmission configuration indicator state indicates a QCL association to the reference resource associated with the channel characteristics prediction configuration.

In some examples, the beam selection component 635 is capable of, configured to, or operable to support a means for receiving, based on the control message, downlink signaling using the receive beam with a spatial filter that is associated with the reference resource.

In some examples, the beam selection component 635 is capable of, configured to, or operable to support a means for selecting the receive beam or the transmit beam during a time domain window based on channel characteristic predictions associated with the reference resource.

In some examples, the beam selection component 635 is capable of, configured to, or operable to support a means for selecting the receive beam or the transmit beam in a radio frequency spectrum band that is based on channel characteristic predictions associated with the reference resource.

In some examples, the transmission configuration indicator state identifies a channel state information report setting. In some examples, selecting the receive beam or the transmit beam is based on the channel state information report setting.

In some examples, the control message includes an identifier of one or more predicted channel characteristics associated with the reference resource. In some examples, selecting the receive beam or the transmit beam is based on the identifier of the one or more predicted channel characteristics.

In some examples, the transmission configuration indicator state includes an identifier of one or more predicted channel characteristics associated with the reference resource. In some examples, selecting the receive beam or the transmit beam is based on the identifier of the one or more predicted channel characteristics.

In some examples, the receive beam or the transmit beam is selected based on channel characteristics predictions associated with the reference resource in a most recent channel state information report transmitted by the UE.

In some examples, the transmission configuration indicator state includes a serving cell identifier or a frequency range identifier, or both.

In some examples, the reference resource is associated with a spatial domain channel characteristics prediction, a time domain channel characteristics prediction, or a frequency domain channel characteristics prediction, or any combination thereof.

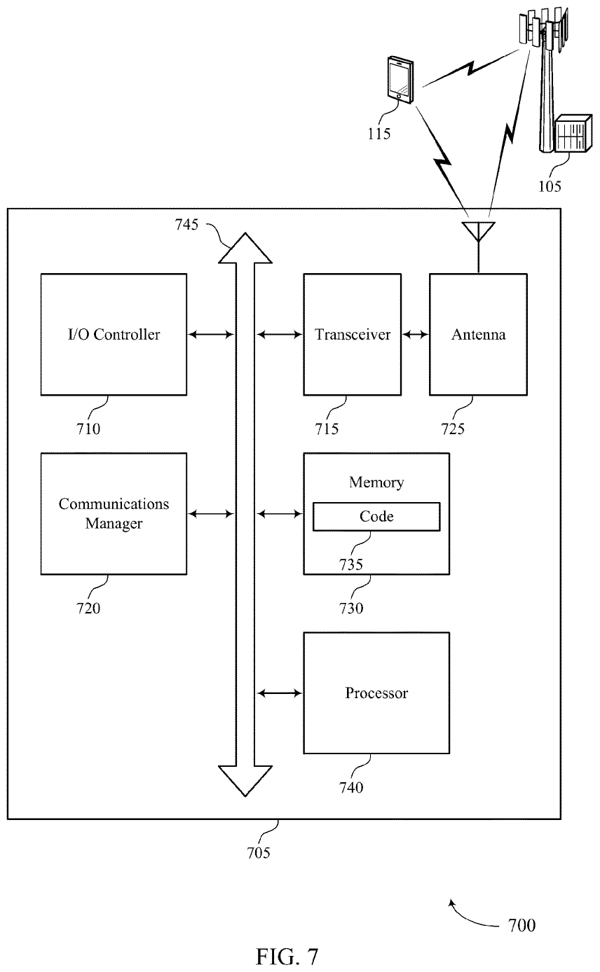

FIG. 7 shows a diagram of a system 700 including a device 705 that supports TCI states for spatial beam prediction in accordance with one or more aspects of the present disclosure. The device 705 may be an example of or include the components of a device 405, a device 505, or a UE 115 as described herein. The device 705 may communicate (e.g., wirelessly) with one or more network entities 105, one or more UEs 115, or any combination thereof. The device 705 may include components for bi-directional voice and data communications including components for transmitting and receiving communications, such as a communications manager 720, an input/output (I/O) controller 710, a transceiver 715, an antenna 725, a memory 730, code 735, and a processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally, or alternatively, the I/O controller 710 may represent or interact with a modem, a keyboard, a mouse, a touchscreen, or a similar device. In some cases, the I/O controller 710 may be implemented as part of a processor, such as the processor 740. In some cases, a user may interact with the device 705 via the I/O controller 710 or via hardware components controlled by the I/O controller 710.

In some cases, the device 705 may include a single antenna 725. However, in some other cases, the device 705 may have more than one antenna 725, which may be capable of concurrently transmitting or receiving multiple wireless transmissions. The transceiver 715 may communicate bi-directionally, via the one or more antennas 725, wired, or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The memory 730 may include random access memory (RAM) and read-only memory (ROM). The memory 730 may store computer-readable, computer-executable code 735 including instructions that, when executed by the processor 740, cause the device 705 to perform various functions described herein. The code 735 may be stored in a non-transitory computer-readable medium such as system memory or another type of memory. In some cases, the code 735 may not be directly executable by the processor 740 but may cause a computer (e.g., when compiled and executed) to perform functions described herein. In some cases, the memory 730 may contain, among other things, a basic I/O system (BIOS) which may control basic hardware or software operation such as the interaction with peripheral components or devices.

The processor 740 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 740 may be configured to operate a memory array using a memory controller. In some other cases, a memory controller may be integrated into the processor 740. The processor 740 may be configured to execute computer-readable instructions stored in a memory (e.g., the memory 730) to cause the device 705 to perform various functions (e.g., functions or tasks supporting TCI states for spatial beam prediction). For example, the device 705 or a component of the device 705 may include a processor 740 and memory 730 coupled with or to the processor 740, the processor 740 and memory 730 configured to perform various functions described herein.

The communications manager 720 may support wireless communications at a UE in accordance with examples as disclosed herein. For example, the communications manager 720 is capable of, configured to, or operable to support a means for receiving control signaling configuring one or more transmission configuration indicator states with reference resources associated with channel characteristics prediction configurations. The communications manager 720 is capable of, configured to, or operable to support a means for receiving a control message indicating a transmission configuration indicator state of the one or more transmission configuration indicator states, the transmission configuration indicator state having a reference resource associated with a channel characteristics prediction configuration. The communications manager 720 is capable of, configured to, or operable to support a means for selecting a receive beam or a transmit beam, or both, based on the reference resource associated with the channel characteristics prediction configuration.

By including or configuring the communications manager 720 in accordance with examples as described herein, the device 705 may support techniques for reduced latency, more efficient utilization of communication resources, and improved coordination between devices.

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described with reference to the communications manager 720 may be supported by or performed by the processor 740, the memory 730, the code 735, or any combination thereof. For example, the code 735 may include instructions executable by the processor 740 to cause the device 705 to perform various aspects of TCI states for spatial beam prediction as described herein, or the processor 740 and the memory 730 may be otherwise configured to perform or support such operations.

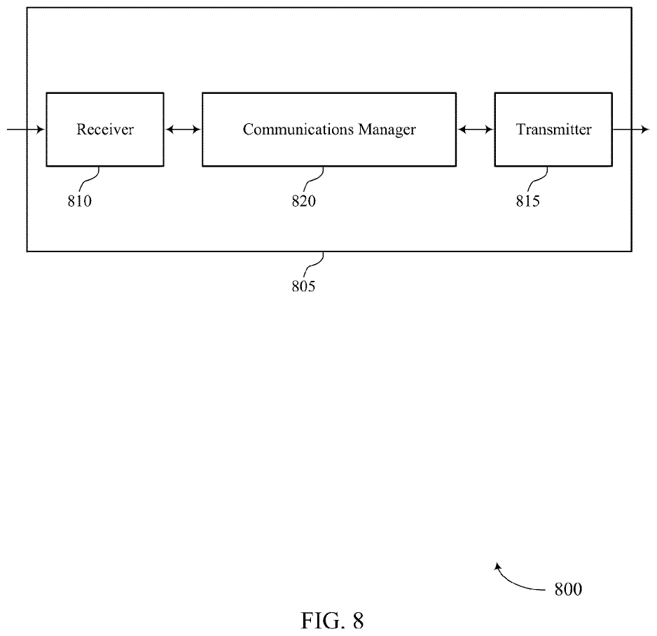

FIG. 8 shows a block diagram 800 of a device 805 that supports TCI states for spatial beam prediction in accordance with one or more aspects of the present disclosure. The device 805 may be an example of aspects of a network entity 105 as described herein. The device 805 may include a receiver 810, a transmitter 815, and a communications manager 820. The device 805 may also include a processor. Each of these components may be in communication with one another (e.g., via one or more buses).

The receiver 810 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 805. In some examples, the receiver 810 may support obtaining information by receiving signals via one or more antennas. Additionally, or alternatively, the receiver 810 may support obtaining information by receiving signals via one or more wired (e.g., electrical, fiber optic) interfaces, wireless interfaces, or any combination thereof.

The transmitter 815 may provide a means for outputting (e.g., transmitting, providing, conveying, sending) information generated by other components of the device 805. For example, the transmitter 815 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 815 may support outputting information by transmitting signals via one or more antennas. Additionally, or alternatively, the transmitter 815 may support outputting information by transmitting signals via one or more wired (e.g., electrical, fiber optic) interfaces, wireless interfaces, or any combination thereof. In some examples, the transmitter 815 and the receiver 810 may be co-located in a transceiver, which may include or be coupled with a modem.

The communications manager 820, the receiver 810, the transmitter 815, or various combinations thereof or various components thereof may be examples of means for performing various aspects of TCI states for spatial beam prediction as described herein. For example, the communications manager 820, the receiver 810, the transmitter 815, or various combinations or components thereof may support a method for performing one or more of the functions described herein.

In some examples, the communications manager 820, the receiver 810, the transmitter 815, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 820, the receiver 810, the transmitter 815, or various combinations or components thereof may be implemented in code (e.g., as communications management software or firmware) executed by a processor. If implemented in code executed by a processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications at a network entity in accordance with examples as disclosed herein. For example, the communications manager 820 is capable of, configured to, or operable to support a means for transmitting, to a UE, control signaling configuring one or more TCI states with reference resources associated with channel characteristics prediction configurations. The communications manager 820 is capable of, configured to, or operable to support a means for transmitting a control message indicating a TCI state of the one or more TCI states, the TCI state having a reference resource associated with a channel characteristics prediction configuration. The communications manager 820 is capable of, configured to, or operable to support a means for communicating with the UE using a receive beam or a transmit beam, or both, based on the reference resource associated with the channel characteristics prediction configuration.

By including or configuring the communications manager 820 in accordance with examples as described herein, the device 805 (e.g., a processor controlling or otherwise coupled with the receiver 810, the transmitter 815, the communications manager 820, or a combination thereof) may support techniques for reduced processing and more efficient utilization of communication resources.

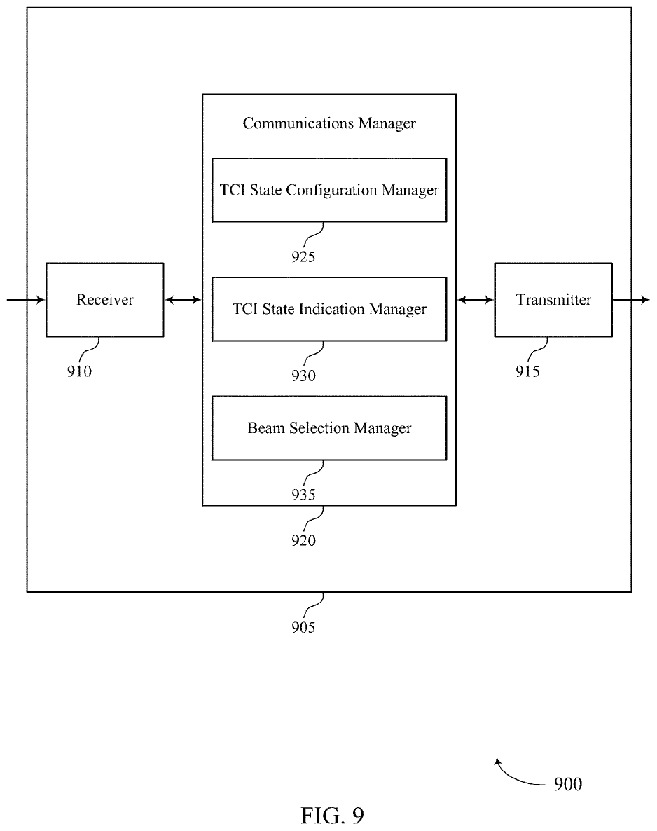

FIG. 9 shows a block diagram 900 of a device 905 that supports TCI states for spatial beam prediction in accordance with one or more aspects of the present disclosure. The device 905 may be an example of aspects of a device 805 or a network entity 105 as described herein. The device 905 may include a receiver 910, a transmitter 915, and a communications manager 920. The device 905 may also include a processor. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas.

Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The device 905, or various components thereof, may be an example of means for performing various aspects of TCI states for spatial beam prediction as described herein. For example, the communications manager 920 may include a TCI state configuration manager 925, a TCI state indication manager 930, a beam selection manager 935, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications at a network entity in accordance with examples as disclosed herein. The TCI state configuration manager 925 is capable of, configured to, or operable to support a means for transmitting, to a UE, control signaling configuring one or more TCI states with reference resources associated with channel characteristics prediction configurations.

The TCI state indication manager 930 is capable of, configured to, or operable to support a means for transmitting a control message indicating a TCI state of the one or more TCI states, the TCI state having a reference resource associated with a channel characteristics prediction configuration. The beam selection manager 935 is capable of, configured to, or operable to support a means for communicating with the UE using a receive beam or a transmit beam, or both, based on the reference resource associated with the channel characteristics prediction configuration.

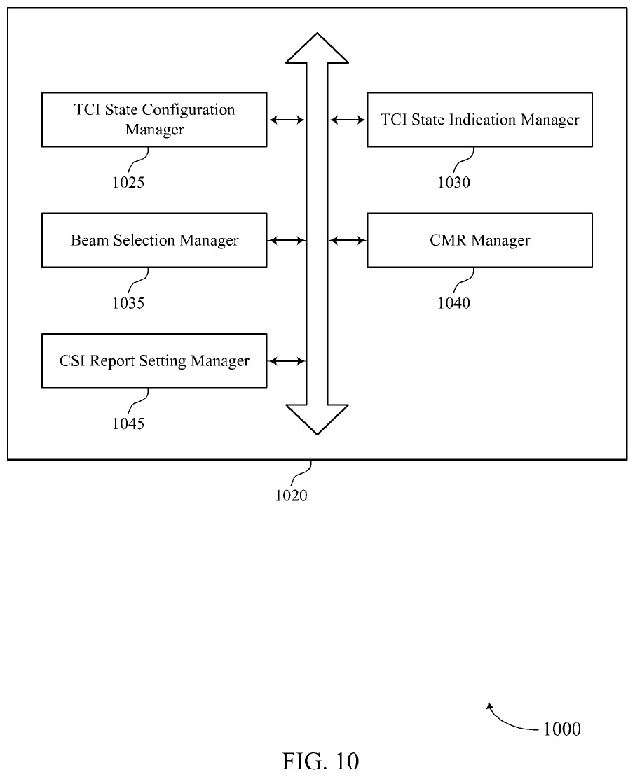

FIG. 10 shows a block diagram 1000 of a communications manager 1020 that supports TCI states for spatial beam prediction in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of TCI states for spatial beam prediction as described herein. For example, the communications manager 1020 may include a TCI state configuration manager 1025, a TCI state indication manager 1030, a beam selection manager 1035, an CMR manager 1040, a CSI report setting manager 1045, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1020 may support wireless communications at a network entity in accordance with examples as disclosed herein. The TCI state configuration manager 1025 is capable of, configured to, or operable to support a means for transmitting, to a UE, control signaling configuring one or more TCI states with reference resources associated with channel characteristics prediction configurations. The TCI state indication manager 1030 is capable of, configured to, or operable to support a means for transmitting a control message indicating a TCI state of the one or more TCI states, the TCI state having a reference resource associated with a channel characteristics prediction configuration. The beam selection manager 1035 is capable of, configured to, or operable to support a means for communicating with the UE using a receive beam or a transmit beam, or both, based on the reference resource associated with the channel characteristics prediction configuration.

In some examples, to support transmitting the control message, the CMR manager 1040 is capable of, configured to, or operable to support a means for transmitting, via the control message, an indication of the TCI state that identifies a set of channel measurement resources as the reference resource, where the receive beam or the transmit beam is based at least part on channel characteristics predicted via the set of channel measurement resources.

In some examples, to support transmitting the control message, the CSI report setting manager 1045 is capable of, configured to, or operable to support a means for transmitting, via the control message, an indication of the TCI state that identifies a channel state information report setting as the reference resource, where the receive beam or the transmit beam is based at least part on a received channel state information report for channel characteristics predictions associated with the channel state information report setting.

In some examples, to support transmitting the control message, the TCI state indication manager 1030 is capable of, configured to, or operable to support a means for transmitting, via the control message, an indication to activate the TCI state of the one or more TCI states.

In some examples, the control signaling configures one or more QCL associations associated with the channel characteristics prediction configurations. In some examples, the TCI state indicates a QCL association to the reference resource associated with the channel characteristics prediction configuration.

In some examples, the beam selection manager 1035 is capable of, configured to, or operable to support a means for transmitting, based on the control message, downlink signaling using the transmit beam with a spatial filter that is associated with the reference resource.

In some examples, the beam selection manager 1035 is capable of, configured to, or operable to support a means for selecting the receive beam or the transmit beam during a time domain window based on channel characteristic predictions associated with the reference resource.

In some examples, the beam selection manager 1035 is capable of, configured to, or operable to support a means for selecting the receive beam or the transmit beam in a radio frequency spectrum band that is based on channel characteristic predictions associated with the reference resource.

In some examples, the TCI state identifies a channel state information report setting. In some examples, the receive beam or the transmit beam is based on the channel state information report setting.

In some examples, the control message includes an identifier of one or more predicted channel characteristics associated with the reference resource. In some examples, the receive beam or the transmit beam is based on the identifier of the one or more predicted channel characteristics.

In some examples, the TCI state includes an identifier of one or more predicted channel characteristics associated with the reference resource. In some examples, the receive beam or the transmit beam is based on the identifier of the one or more predicted channel characteristics.

In some examples, the TCI state is based on channel characteristics predictions associated with the reference resource in a most recent channel state information report received from the UE.

In some examples, the TCI state includes a serving cell identifier or a frequency range identifier, or both.

In some examples, the reference resource is associated with a spatial domain channel characteristics prediction, a time domain channel characteristics prediction, or a frequency domain channel characteristics prediction, or any combination thereof.

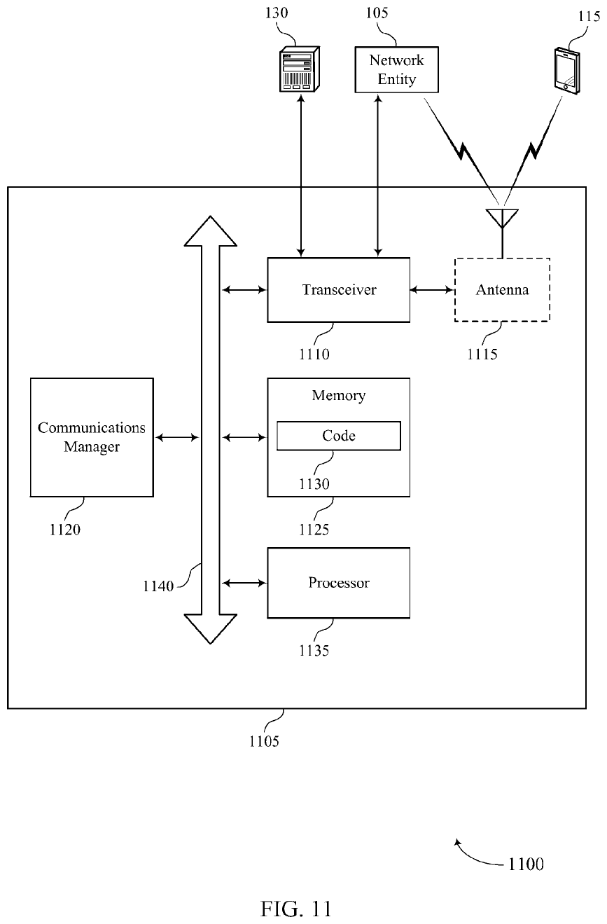

FIG. 11 shows a diagram of a system 1100 including a device 1105 that supports TCI states for spatial beam prediction in accordance with one or more aspects of the present disclosure. The device 1105 may be an example of or include the components of a device 805, a device 905, or a network entity 105 as described herein. The device 1105 may communicate with one or more network entities 105, one or more UEs 115, or any combination thereof, which may include communications over one or more wired interfaces, over one or more wireless interfaces, or any combination thereof. The device 1105 may include components that support outputting and obtaining communications, such as a communications manager 1120, a transceiver 1110, an antenna 1115, a memory 1125, code 1130, and a processor 1135. These components may be in electronic communication or otherwise coupled (e.g., operatively, communicatively, functionally, electronically, electrically) via one or more buses (e.g., a bus 1140).

The transceiver 1110 may support bi-directional communications via wired links, wireless links, or both as described herein. In some examples, the transceiver 1110 may include a wired transceiver and may communicate bi-directionally with another wired transceiver. Additionally, or alternatively, in some examples, the transceiver 1110 may include a wireless transceiver and may communicate bi-directionally with another wireless transceiver. In some examples, the device 1105 may include one or more antennas 1115, which may be capable of transmitting or receiving wireless transmissions (e.g., concurrently). The transceiver 1110 may also include a modem to modulate signals, to provide the modulated signals for transmission (e.g., by one or more antennas 1115, by a wired transmitter), to receive modulated signals (e.g., from one or more antennas 1115, from a wired receiver), and to demodulate signals. In some implementations, the transceiver 1110 may include one or more interfaces, such as one or more interfaces coupled with the one or more antennas 1115 that are configured to support various receiving or obtaining operations, or one or more interfaces coupled with the one or more antennas 1115 that are configured to support various transmitting or outputting operations, or a combination thereof. In some implementations, the transceiver 1110 may include or be configured for coupling with one or more processors or memory components that are operable to perform or support operations based on received or obtained information or signals, or to generate information or other signals for transmission or other outputting, or any combination thereof. In some implementations, the transceiver 1110, or the transceiver 1110 and the one or more antennas 1115, or the transceiver 1110 and the one or more antennas 1115 and one or more processors or memory components (for example, the processor 1135, or the memory 1125, or both), may be included in a chip or chip assembly that is installed in the device 1105. In some examples, the transceiver may be operable to support communications via one or more communications links (e.g., a communication link 125, a backhaul communication link 120, a midhaul communication link 162, a fronthaul communication link 168).

The memory 1125 may include RAM and ROM. The memory 1125 may store computer-readable, computer-executable code 1130 including instructions that, when executed by the processor 1135, cause the device 1105 to perform various functions described herein. The code 1130 may be stored in a non-transitory computer-readable medium such as system memory or another type of memory. In some cases, the code 1130 may not be directly executable by the processor 1135 but may cause a computer (e.g., when compiled and executed) to perform functions described herein. In some cases, the memory 1125 may contain, among other things, a BIOS which may control basic hardware or software operation such as the interaction with peripheral components or devices.

The processor 1135 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1135 may be configured to operate a memory array using a memory controller. In some other cases, a memory controller may be integrated into the processor 1135. The processor 1135 may be configured to execute computer-readable instructions stored in a memory (e.g., the memory 1125) to cause the device 1105 to perform various functions (e.g., functions or tasks supporting TCI states for spatial beam prediction). For example, the device 1105 or a component of the device 1105 may include a processor 1135 and memory 1125 coupled with the processor 1135, the processor 1135 and memory 1125 configured to perform various functions described herein. The processor 1135 may be an example of a cloud-computing platform (e.g., one or more physical nodes and supporting software such as operating systems, virtual machines, or container instances) that may host the functions (e.g., by executing code 1130) to perform the functions of the device 1105. The processor 1135 may be any one or more suitable processors capable of executing scripts or instructions of one or more software programs stored in the device 1105 (such as within the memory 1125). In some implementations, the processor 1135 may be a component of a processing system. A processing system may generally refer to a system or series of machines or components that receives inputs and processes the inputs to produce a set of outputs (which may be passed to other systems or components of, for example, the device 1105). For example, a processing system of the device 1105 may refer to a system including the various other components or subcomponents of the device 1105, such as the processor 1135, or the transceiver 1110, or the communications manager 1120, or other components or combinations of components of the device 1105. The processing system of the device 1105 may interface with other components of the device 1105, and may process information received from other components (such as inputs or signals) or output information to other components. For example, a chip or modem of the device 1105 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1105 may transmit information output from the chip or modem. Additionally, or alternatively, in some implementations, the one or more interfaces may refer to an interface between the processing system of the chip or modem and a receiver, such that the device 1105 may obtain information or signal inputs, and the information may be passed to the processing system. A person having ordinary skill in the art will readily recognize that a first interface also may obtain information or signal inputs, and a second interface also may output information or signal outputs.

In some examples, a bus 1140 may support communications of (e.g., within) a protocol layer of a protocol stack. In some examples, a bus 1140 may support communications associated with a logical channel of a protocol stack (e.g., between protocol layers of a protocol stack), which may include communications performed within a component of the device 1105, or between different components of the device 1105 that may be co-located or located in different locations (e.g., where the device 1105 may refer to a system in which one or more of the communications manager 1120, the transceiver 1110, the memory 1125, the code 1130, and the processor 1135 may be located in one of the different components or divided between different components).

In some examples, the communications manager 1120 may manage aspects of communications with a core network 130 (e.g., via one or more wired or wireless backhaul links). For example, the communications manager 1120 may manage the transfer of data communications for client devices, such as one or more UEs 115. In some examples, the communications manager 1120 may manage communications with other network entities 105, and may include a controller or scheduler for controlling communications with UEs 115 in cooperation with other network entities 105. In some examples, the communications manager 1120 may support an X2 interface within an LTE/LTE-A wireless communications network technology to provide communication between network entities 105.

The communications manager 1120 may support wireless communications at a network entity in accordance with examples as disclosed herein. For example, the communications manager 1120 is capable of, configured to, or operable to support a means for transmitting, to a UE, control signaling configuring one or more TCI states with reference resources associated with channel characteristics prediction configurations. The communications manager 1120 is capable of, configured to, or operable to support a means for transmitting a control message indicating a TCI state of the one or more TCI states, the TCI state having a reference resource associated with a channel characteristics prediction configuration. The communications manager 1120 is capable of, configured to, or operable to support a means for communicating with the UE using a receive beam or a transmit beam, or both, based on the reference resource associated with the channel characteristics prediction configuration.

By including or configuring the communications manager 1120 in accordance with examples as described herein, the device 1105 may support techniques for reduced latency, more efficient utilization of communication resources, and improved coordination between devices.

In some examples, the communications manager 1120 may be configured to perform various operations (e.g., receiving, obtaining, monitoring, outputting, transmitting) using or otherwise in cooperation with the transceiver 1110, the one or more antennas 1115 (e.g., where applicable), or any combination thereof. Although the communications manager 1120 is illustrated as a separate component, in some examples, one or more functions described with reference to the communications manager 1120 may be supported by or performed by the transceiver 1110, the processor 1135, the memory 1125, the code 1130, or any combination thereof. For example, the code 1130 may include instructions executable by the processor 1135 to cause the device 1105 to perform various aspects of TCI states for spatial beam prediction as described herein, or the processor 1135 and the memory 1125 may be otherwise configured to perform or support such operations.

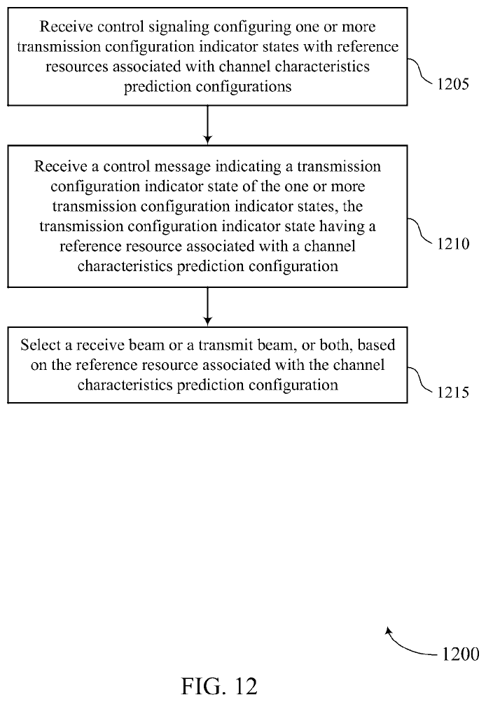

FIG. 12 shows a flowchart illustrating a method 1200 that supports TCI states for spatial beam prediction in accordance with aspects of the present disclosure. The operations of the method 1200 may be implemented by a UE or its components as described herein. For example, the operations of the method 1200 may be performed by a UE 115 as described with reference to FIGS. 1 through 7. In some examples, a UE may execute a set of instructions to control the functional elements of the wireless UE to perform the described functions. Additionally, or alternatively, the wireless UE may perform aspects of the described functions using special-purpose hardware.

At 1205, the method may include receiving control signaling configuring one or more transmission configuration indicator states with reference resources associated with channel characteristics prediction configurations. The operations of 1205 may be performed in accordance with examples as disclosed herein. In some examples, aspects of the operations of 1205 may be performed by a TCI state configuration component 625 as described with reference to FIG. 6.

At 1210, the method may include receiving a control message indicating a transmission configuration indicator state of the one or more transmission configuration indicator states, the transmission configuration indicator state having a reference resource associated with a channel characteristics prediction configuration. The operations of 1210 may be performed in accordance with examples as disclosed herein. In some examples, aspects of the operations of 1210 may be performed by a TCI state indication component 630 as described with reference to FIG. 6.

At 1215, the method may include selecting a receive beam or a transmit beam, or both, based on the reference resource associated with the channel characteristics prediction configuration. The operations of 1215 may be performed in accordance with examples as disclosed herein. In some examples, aspects of the operations of 1215 may be performed by a beam selection component 635 as described with reference to FIG. 6.

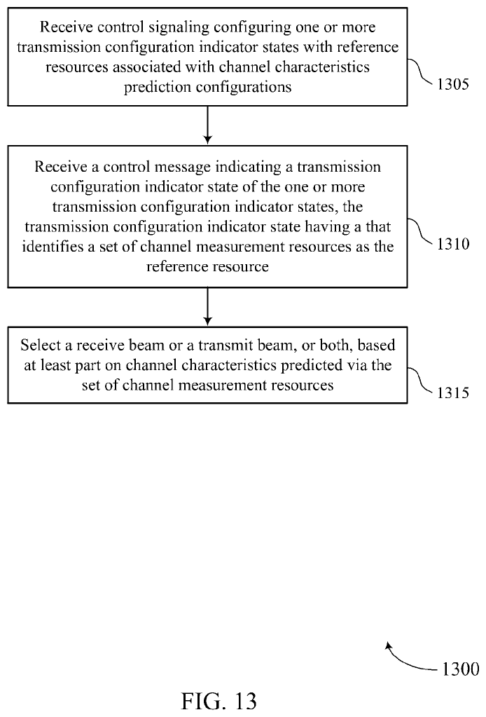

FIG. 13 shows a flowchart illustrating a method 1300 that supports TCI states for spatial beam prediction in accordance with aspects of the present disclosure. The operations of the method 1300 may be implemented by a UE or its components as described herein. For example, the operations of the method 1300 may be performed by a UE 115 as described with reference to FIGS. 1 through 7. In some examples, a UE may execute a set of instructions to control the functional elements of the wireless UE to perform the described functions. Additionally, or alternatively, the wireless UE may perform aspects of the described functions using special-purpose hardware.

At 1305, the method may include receiving control signaling configuring one or more transmission configuration indicator states with reference resources associated with channel characteristics prediction configurations. The operations of 1305 may be performed in accordance with examples as disclosed herein. In some examples, aspects of the operations of 1305 may be performed by a TCI state configuration component 625 as described with reference to FIG. 6.

At 1310, the method may include receiving a control message indicating a transmission configuration indicator state of the one or more transmission configuration indicator states that identifies a set of channel measurement resources as the reference resource. The operations of 1310 may be performed in accordance with examples as disclosed herein. In some examples, aspects of the operations of 1310 may be performed by a TCI state indication component 630 as described with reference to FIG. 6.

At 1315, the method may include receiving, via the control message, an indication of the transmission configuration indicator state that identifies a set of channel measurement resources as the reference resource, where selecting the receive beam or the transmit beam is based at least part on channel characteristics predicted via the set of channel measurement resources. The operations of 1315 may be performed in accordance with examples as disclosed herein. In some examples, aspects of the operations of 1315 may be performed by an CMR component 640 as described with reference to FIG. 6.

At 1320, the method may include selecting a receive beam or a transmit beam, or both, based at least part on channel characteristics predicted via the set of channel measurement resources. The operations of 1320 may be performed in accordance with examples as disclosed herein. In some examples, aspects of the operations of 1320 may be performed by a beam selection component 635 as described with reference to FIG. 6.

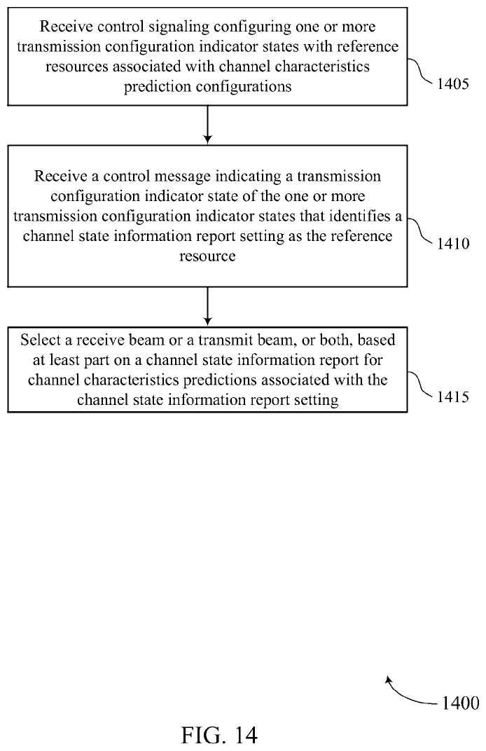

FIG. 14 shows a flowchart illustrating a method 1400 that supports TCI states for spatial beam prediction in accordance with aspects of the present disclosure. The operations of the method 1400 may be implemented by a UE or its components as described herein. For example, the operations of the method 1400 may be performed by a UE 115 as described with reference to FIGS. 1 through 7. In some examples, a UE may execute a set of instructions to control the functional elements of the wireless UE to perform the described functions. Additionally, or alternatively, the wireless UE may perform aspects of the described functions using special-purpose hardware.

At 1405, the method may include receiving control signaling configuring one or more transmission configuration indicator states with reference resources associated with channel characteristics prediction configurations. The operations of 1405 may be performed in accordance with examples as disclosed herein. In some examples, aspects of the operations of 1405 may be performed by a TCI state configuration component 625 as described with reference to FIG. 6.

At 1410, the method may include receiving a control message indicating a transmission configuration indicator state of the one or more transmission configuration indicator states that identifies a channel state information report setting as the reference resource. The operations of 1410 may be performed in accordance with examples as disclosed herein. In some examples, aspects of the operations of 1410 may be performed by a TCI state indication component 630 as described with reference to FIG. 6.

At 1415, the method may include receiving, via the control message, an indication of the transmission configuration indicator state that identifies a channel state information report setting as the reference resource, where selecting the receive beam or the transmit beam is based at least part on a channel state information report for channel characteristics predictions associated with the channel state information report setting. The operations of 1415 may be performed in accordance with examples as disclosed herein. In some examples, aspects of the operations of 1415 may be performed by a CSI report setting component 645 as described with reference to FIG. 6.

At 1420, the method may include selecting a receive beam or a transmit beam, or both, based on the reference resource associated with the channel characteristics prediction configuration. The operations of 1420 may be performed in accordance with examples as disclosed herein. In some examples, aspects of the operations of 1420 may be performed by a beam selection component 635 as described with reference to FIG. 6.

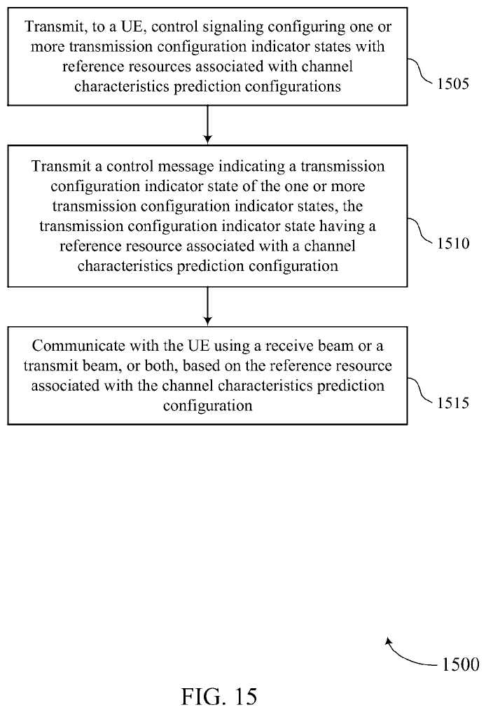

FIG. 15 shows a flowchart illustrating a method 1500 that supports TCI states for spatial beam prediction in accordance with aspects of the present disclosure. The operations of the method 1500 may be implemented by a network entity or its components as described herein. For example, the operations of the method 1500 may be performed by a network entity as described with reference to FIGS. 1 through 3 and 8 through 11. In some examples, a network entity may execute a set of instructions to control the functional elements of the wireless network entity to perform the described functions. Additionally, or alternatively, the wireless network entity may perform aspects of the described functions using special-purpose hardware.

At 1505, the method may include transmitting, to a UE, control signaling configuring one or more transmission configuration indicator states with reference resources associated with channel characteristics prediction configurations. The operations of 1505 may be performed in accordance with examples as disclosed herein. In some examples, aspects of the operations of 1505 may be performed by a TCI state configuration manager 1025 as described with reference to FIG. 10.

At 1510, the method may include transmitting a control message indicating a transmission configuration indicator state of the one or more transmission configuration indicator states, the transmission configuration indicator state having a reference resource associated with a channel characteristics prediction configuration. The operations of 1510 may be performed in accordance with examples as disclosed herein. In some examples, aspects of the operations of 1510 may be performed by a TCI state indication manager 1030 as described with reference to FIG. 10.

At 1515, the method may include communicating with the UE using a receive beam or a transmit beam, or both, based on the reference resource associated with the channel characteristics prediction configuration. The operations of 1515 may be performed in accordance with examples as disclosed herein. In some examples, aspects of the operations of 1515 may be performed by a beam selection manager 1035 as described with reference to FIG. 10.

The following provides an overview of aspects of the present disclosure:

Aspect 1: A method for wireless communications at a UE, comprising: receiving control signaling configuring one or more transmission configuration indicator states with reference resources associated with channel characteristics prediction configurations; receiving a control message indicating a transmission configuration indicator state of the one or more transmission configuration indicator states, the transmission configuration indicator state having a reference resource associated with a channel characteristics prediction configuration; and selecting a receive beam or a transmit beam, or both, based at least in part on the reference resource associated with the channel characteristics prediction configuration.

Aspect 2: The method of aspect 1, wherein receiving the control message comprises: receiving, via the control message, an indication of the transmission configuration indicator state that identifies a set of channel measurement resources as the reference resource, wherein selecting the receive beam or the transmit beam is based at least part on channel characteristics predicted via the set of channel measurement resources.

Aspect 3: The method of any of aspects 1 through 2, wherein receiving the control message comprises: receiving, via the control message, an indication of the transmission configuration indicator state that identifies a channel state information report setting as the reference resource, wherein selecting the receive beam or the transmit beam is based at least part on a channel state information report for channel characteristics predictions associated with the channel state information report setting.

Aspect 4: The method of any of aspects 1 through 3, wherein receiving the control message comprises: receiving, via the control message, an indication to activate the transmission configuration indicator state of the one or more transmission configuration indicator states.

Aspect 5: The method of any of aspects 1 through 4, wherein the control signaling configures one or more quasi co-location associations associated with the channel characteristics prediction configurations, the transmission configuration indicator state indicates a quasi co-location association to the reference resource associated with the channel characteristics prediction configuration.

Aspect 6: The method of any of aspects 1 through 5, further comprising: receiving, based at least in part on the control message, downlink signaling using the receive beam with a spatial filter that is associated with the reference resource.

Aspect 7: The method of any of aspects 1 through 6, further comprising: selecting the receive beam or the transmit beam during a time domain window based at least in part on channel characteristic predictions associated with the reference resource.

Aspect 8: The method of any of aspects 1 through 7, further comprising: selecting the receive beam or the transmit beam in a radio frequency spectrum band that is based at least in part on channel characteristic predictions associated with the reference resource.

Aspect 9: The method of any of aspects 1 through 8, wherein the transmission configuration indicator state identifies a channel state information report setting, selecting the receive beam or the transmit beam is based at least in part on the channel state information report setting.

Aspect 10: The method of any of aspects 1 through 9, wherein the control message comprises an identifier of one or more predicted channel characteristics associated with the reference resource, selecting the receive beam or the transmit beam is based at least in part on the identifier of the one or more predicted channel characteristics.

Aspect 11: The method of any of aspects 1 through 10, wherein the transmission configuration indicator state comprises an identifier of one or more predicted channel characteristics associated with the reference resource, selecting the receive beam or the transmit beam is based at least in part on the identifier of the one or more predicted channel characteristics.

Aspect 12: The method of any of aspects 1 through 11, wherein the receive beam or the transmit beam is selected based at least in part on channel characteristics predictions associated with the reference resource in a most recent channel state information report transmitted by the UE.

Aspect 13: The method of any of aspects 1 through 12, wherein the transmission configuration indicator state includes a serving cell identifier or a frequency range identifier, or both.

Aspect 14: The method of any of aspects 1 through 13, wherein the reference resource is associated with a spatial domain channel characteristics prediction, a time domain channel characteristics prediction, or a frequency domain channel characteristics prediction, or any combination thereof.

Aspect 15: A method for wireless communications at a network entity, comprising: transmitting, to a UE, control signaling configuring one or more transmission configuration indicator states with reference resources associated with channel characteristics prediction configurations; transmitting a control message indicating a transmission configuration indicator state of the one or more transmission configuration indicator states, the transmission configuration indicator state having a reference resource associated with a channel characteristics prediction configuration; and communicating with the UE using a receive beam or a transmit beam, or both, based at least in part on the reference resource associated with the channel characteristics prediction configuration.

Aspect 16: The method of aspect 15, wherein transmitting the control message comprises: transmitting, via the control message, an indication of the transmission configuration indicator state that identifies a set of channel measurement resources as the reference resource, wherein the receive beam or the transmit beam is based at least part on channel characteristics predicted via the set of channel measurement resources.

Aspect 17: The method of any of aspects 15 through 16, wherein transmitting the control message comprises: transmitting, via the control message, an indication of the transmission configuration indicator state that identifies a channel state information report setting as the reference resource, wherein the receive beam or the transmit beam is based at least part on a received channel state information report for channel characteristics predictions associated with the channel state information report setting.

Aspect 18: The method of any of aspects 15 through 17, wherein transmitting the control message comprises: transmitting, via the control message, an indication to activate the transmission configuration indicator state of the one or more transmission configuration indicator states.

Aspect 19: The method of any of aspects 15 through 18, wherein the control signaling configures one or more quasi co-location associations associated with the channel characteristics prediction configurations, the transmission configuration indicator state indicates a quasi co-location association to the reference resource associated with the channel characteristics prediction configuration.

Aspect 20: The method of any of aspects 15 through 19, further comprising: transmitting, based at least in part on the control message, downlink signaling using the transmit beam with a spatial filter that is associated with the reference resource.

Aspect 21: The method of any of aspects 15 through 20, further comprising: selecting the receive beam or the transmit beam during a time domain window based at least in part on channel characteristic predictions associated with the reference resource.

Aspect 22: The method of any of aspects 15 through 21, further comprising: selecting the receive beam or the transmit beam in a radio frequency spectrum band that is based at least in part on channel characteristic predictions associated with the reference resource.

Aspect 23: The method of any of aspects 15 through 22, wherein the transmission configuration indicator state identifies a channel state information report setting, the receive beam or the transmit beam is based at least in part on the channel state information report setting.

Aspect 24: The method of any of aspects 15 through 23, wherein the control message comprises an identifier of one or more predicted channel characteristics associated with the reference resource, the receive beam or the transmit beam is based at least in part on the identifier of the one or more predicted channel characteristics.

Aspect 25: The method of any of aspects 15 through 24, wherein the transmission configuration indicator state comprises an identifier of one or more predicted channel characteristics associated with the reference resource, the receive beam or the transmit beam is based at least in part on the identifier of the one or more predicted channel characteristics.

Aspect 26: The method of any of aspects 15 through 25, wherein the transmission configuration indicator state is based at least in part on channel characteristics predictions associated with the reference resource in a most recent channel state information report received from the UE.

Aspect 27: The method of any of aspects 15 through 26, wherein the transmission configuration indicator state includes a serving cell identifier or a frequency range identifier, or both.

Aspect 28: The method of any of aspects 15 through 27, wherein the reference resource is associated with a spatial domain channel characteristics prediction, a time domain channel characteristics prediction, or a frequency domain channel characteristics prediction, or any combination thereof.

Aspect 29: An apparatus for wireless communications at a UE, comprising a processor; memory coupled with the processor; and instructions stored in the memory and executable by the processor to cause the apparatus to perform a method of any of aspects 1 through 14.

Aspect 30: An apparatus for wireless communications at a UE, comprising at least one means for performing a method of any of aspects 1 through 14.

Aspect 31: A non-transitory computer-readable medium storing code for wireless communications at a UE, the code comprising instructions executable by a processor to perform a method of any of aspects 1 through 14.

Aspect 32: An apparatus for wireless communications at a network entity, comprising a processor; memory coupled with the processor; and instructions stored in the memory and executable by the processor to cause the apparatus to perform a method of any of aspects 15 through 28.

Aspect 33: An apparatus for wireless communications at a network entity, comprising at least one means for performing a method of any of aspects 15 through 28.

Aspect 34: A non-transitory computer-readable medium storing code for wireless communications at a network entity, the code comprising instructions executable by a processor to perform a method of any of aspects 15 through 28.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. An apparatus for wireless communications at a user equipment (UE), comprising:
a processor;
memory coupled with the processor; and
instructions stored in the memory and executable by the processor to cause the apparatus to:
receive control signaling configuring one or more transmission configuration indicator states with reference resources associated with channel characteristics prediction configurations;
receive a control message indicating a transmission configuration indicator state of the one or more transmission configuration indicator states, the transmission configuration indicator state having a reference resource associated with a channel characteristics prediction configuration; and
select a receive beam or a transmit beam, or both, based at least in part on the reference resource associated with the channel characteristics prediction configuration.

2. The apparatus of claim 1, wherein the instructions to receive the control message are executable by the processor to cause the apparatus to:
receive, via the control message, an indication of the transmission configuration indicator state that identifies a set of channel measurement resources as the reference resource, wherein selecting the receive beam or the transmit beam is based at least part on channel characteristics predicted via the set of channel measurement resources.

3. The apparatus of claim 1, wherein the instructions to receive the control message are executable by the processor to cause the apparatus to:
receive, via the control message, an indication of the transmission configuration indicator state that identifies a channel state information report setting as the reference resource, wherein selecting the receive beam or the transmit beam is based at least part on a channel state information report for channel characteristics predictions associated with the channel state information report setting.

4. The apparatus of claim 1, wherein the instructions to receive the control message are executable by the processor to cause the apparatus to:
receive, via the control message, an indication to activate the transmission configuration indicator state of the one or more transmission configuration indicator states.

5. The apparatus of claim 1, wherein:
the control signaling configures one or more quasi co-location associations associated with the channel characteristics prediction configurations; and
the transmission configuration indicator state indicates a quasi co-location association to the reference resource associated with the channel characteristics prediction configuration.

6. The apparatus of claim 1, wherein the instructions are further executable by the processor to cause the apparatus to:
receive, based at least in part on the control message, downlink signaling using the receive beam with a spatial filter that is associated with the reference resource.

7. The apparatus of claim 1, wherein the instructions are further executable by the processor to cause the apparatus to:
select the receive beam or the transmit beam during a time domain window based at least in part on channel characteristic predictions associated with the reference resource.

8. The apparatus of claim 1, wherein the instructions are further executable by the processor to cause the apparatus to:
select the receive beam or the transmit beam in a radio frequency spectrum band that is based at least in part on channel characteristic predictions associated with the reference resource.

9. The apparatus of claim 1, wherein:
the transmission configuration indicator state identifies a channel state information report setting, and wherein selecting the receive beam or the transmit beam is based at least in part on the channel state information report setting.

10. The apparatus of claim 1, wherein:
the control message comprises an identifier of one or more predicted channel characteristics associated with the reference resource, and wherein selecting the receive beam or the transmit beam is based at least in part on the identifier of the one or more predicted channel characteristics.

11. The apparatus of claim 1, wherein:
the transmission configuration indicator state comprises an identifier of one or more predicted channel characteristics associated with the reference resource, and wherein selecting the receive beam or the transmit beam is based at least in part on the identifier of the one or more predicted channel characteristics.

12. The apparatus of claim 1, wherein the receive beam or the transmit beam is selected based at least in part on channel characteristics predictions associated with the reference resource in a most recent channel state information report transmitted by the UE.

13. The apparatus of claim 1, wherein the transmission configuration indicator state includes a serving cell identifier or a frequency range identifier, or both.

14. The apparatus of claim 1, wherein the reference resource is associated with a spatial domain channel characteristics prediction, a time domain channel characteristics prediction, or a frequency domain channel characteristics prediction, or any combination thereof.

15. An apparatus for wireless communications at a network entity, comprising:
a processor;
memory coupled with the processor; and
instructions stored in the memory and executable by the processor to cause the apparatus to:
transmit, to a user equipment (UE), control signaling configuring one or more transmission configuration indicator states with reference resources associated with channel characteristics prediction configurations;
transmit a control message indicating a transmission configuration indicator state of the one or more transmission configuration indicator states, the transmission configuration indicator state having a reference resource associated with a channel characteristics prediction configuration; and
communicate with the UE using a receive beam or a transmit beam, or both, based at least in part on the reference resource associated with the channel characteristics prediction configuration.

16. The apparatus of claim 15, wherein the instructions to transmit the control message are executable by the processor to cause the apparatus to:
transmit, via the control message, an indication of the transmission configuration indicator state that identifies a set of channel measurement resources as the reference resource, wherein the receive beam or the transmit beam is based at least part on channel characteristics predicted via the set of channel measurement resources.

17. The apparatus of claim 15, wherein the instructions to transmit the control message are executable by the processor to cause the apparatus to:
transmit, via the control message, an indication of the transmission configuration indicator state that identifies a channel state information report setting as the reference resource, wherein the receive beam or the transmit beam is based at least part on a received channel state information report for channel characteristics predictions associated with the channel state information report setting.

18. The apparatus of claim 15, wherein the instructions to transmit the control message are executable by the processor to cause the apparatus to:
transmit, via the control message, an indication to activate the transmission configuration indicator state of the one or more transmission configuration indicator states.

19. The apparatus of claim 15, wherein:
the control signaling configures one or more quasi co-location associations associated with the channel characteristics prediction configurations; and
the transmission configuration indicator state indicates a quasi co-location association to the reference resource associated with the channel characteristics prediction configuration.

20-28. (canceled)

29. A method for wireless communications at a user equipment (UE), comprising:
receiving control signaling configuring one or more transmission configuration indicator states with reference resources associated with channel characteristics prediction configurations;
receiving a control message indicating a transmission configuration indicator state of the one or more transmission configuration indicator states, the transmission configuration indicator state having a reference resource associated with a channel characteristics prediction configuration; and
selecting a receive beam or a transmit beam, or both, based at least in part on the reference resource associated with the channel characteristics prediction configuration.

30. (canceled)
